(19) United States
(12) Patent Application Publication
(10) Pub. No.: US 2019/0244097 A1
(43) Pub. Date: Aug. 8, 2019

(54) INFORMATION PROCESSING APPARATUS AND INFORMATION PROCESSING METHOD

(71) Applicant: FUJITSU LIMITED, Kawasaki-shi (JP)

(72) Inventors: Takahiro Notsu, Kawasaki (JP); MAKIKO ITO, Kawasaki (JP)

(73) Assignee: FUJITSU LIMITED, Kawasaki-shi (JP)

(21) Appl. No.: 16/254,837

(22) Filed: Jan. 23, 2019

(30) Foreign Application Priority Data
Feb. 7, 2018 (JP) 2018-019782

(51) Int. Cl. G06N 3/08; G06N 3/04; G06F 7/483

(52) U.S. Cl. CPC G06N 3/08; G06F 7/483; G06N 3/04

(57) ABSTRACT

An information processing apparatus includes a memory and a processor coupled to the memory. The processor acquires statistical information including a distribution of operation result values from the memory, when it is determined that a number of acquired statistical information samples is larger than a predetermined value, generates a program by setting a data type for which a ratio of a maximum value to a minimum value of values that can be expressed is smaller among data types usable for target data in an operation as the target data, and when it is determined that the number of acquired statistical information samples is smaller than the predetermined value, generates the program by setting the data type for which the ratio of the maximum value to the minimum value of values that can be expressed is larger among data types usable for target data in the operation as the target data.

### CROSS-REFERENCE TO RELATED APPLICATION

This application is based upon and claims the benefit of priority of the prior Japanese Patent Application No. 2018-019782, filed on Feb. 7, 2018, the entire contents of which are incorporated herein by reference.

### FIELD

The embodiments discussed herein are related to an information processing apparatus and an information processing method.

### BACKGROUND

Among the machine learning using artificial intelligence, the need for the deep learning (DL) is especially increasing. The deep learning may be considered as a machine learning method using a multilayered neural network (DNN). FIG. 1 is a view exemplifying a configuration of a neural network. The neural network is a model of neurons set on a computer. Neurons have a cell body, dendrites that receive signals input from other cell bodies, and axons that output signals to other cell bodies. A signal transmission structure called a synapse is formed between the end of the axon that outputs a signal and the dendrite that receive the signal. In the neural network, information transmission between the neurons via the synapse is modeled.

The entire neural network is set as one function. When a certain input is given to the neural network, the neural network outputs a predetermined value according to the given input. The neural network is different from a conventional program in that when a target value (teacher signal) in relation to a certain input is given, it is possible to adjust a value output according to the given target value to be closer to the objective. That is, there are a large number of parameters inside the neural network. The neural network gradually implements the form of a target function by adjusting the values of the parameters present therein.

The multilayered neural network is constituted with a plurality of hierarchies. The calculations performed in respective hierarchies have different contents, but each is roughly and largely divided into any one of the following operations. That is, as operations of the multilayered neural network, (a) a convolution operation, (b) a full connect operation (also called an inner product operation), (c) a ReLU (a ramp function) operation (also called an activation operation), (d) a pooling operation, (e) a softmax operation, and (f) an error evaluation operation are exemplified.

For example, in a case of image classification, in the first several layers, convolution, ReLU, and pooling operations are performed, and in upper layers, full connect and ReLU operations are performed. In the last layer, a softmax operation is performed to output a probability of a classification category for an input image. Among calculations in the neural network, the convolution operation and the full connect operation are dominant.

FIG. 2 exemplifies the processing of a convolution operation in the neural network. The convolution operation is also called a filter operation, and is mainly executed on image data. The operation is a product-sum operation Σxw of an element of an input parameter X (vector) and an element of a weight W (vector). A filter is prepared for all input/output channel combinations. In the convolution operation, a bias is added to the sum of results of all the input channels to obtain an output value Z.

FIG. 3 exemplifies a processing of a full connect operation. The full connect operation is also called an inner product operation. In the full connect operation, weights are defined for all input/output pairs. In the full connect operation, product-sum operations of all inputs X{x0, x1, . . . , xc} and their weights W{w00, . . . , wcd} are executed, and biases b{b0, b1, . . . , bd} are added to product-sum operation results to obtain output values Z {z0, z1, . . . , zd}.

In the multilayered neural network, deep learning is executed. Then, the multilayered neural network tends to be scaled up in order to improve a recognition performance of the multilayered neural network where the deep learning is executed. For example, the number of parameters processed in the multilayered neural network ranges from several million to one hundred and several tens of millions. In order for the multilayered neural network to come close to a human brain, it is thought that the number of parameters ultimately approaches one hundred and several tens of billions. Therefore, in the future, it is expected that learning data in the deep learning increases, and thus a calculation load and a memory load in the multilayered neural network increase. Thus, with respect to the continuously increasing learning data, an improvement of a recognition performance and a learning efficiency is required. It is desirable to reduce the weight of the multilayered neural network so that the recognition performance and the learning efficiency are improved so as to reduce a load.

Meanwhile, in the deep learning, various operations including a multiplication, a product-sum operation, and a vector multiplication are executed. Meanwhile, in the deep learning, a requirement for an individual operational accuracy is not as precise as in a normal operation processing. For example, in the normal operation processing, a programmer develops a computer program so as not to cause an occurrence of overflow of digits as much as possible. Meanwhile, in the deep learning, it is permissible that large values are saturated to some extent. This is because, in the deep learning, a main processing is an adjustment of a coefficient (weight) at the time of a convolution operation of a plurality of input data pieces, and extreme data among the input data pieces is not regarded as being important in many cases. Also, this is because since the coefficient is adjusted by repeatedly using a large amount of data, when digit adjustment is performed according to the progress of learning, even a value that was saturated once may be reflected in the adjustment of the coefficient without being saturated.

Therefore, in consideration of such a characteristic of the deep learning, in order to achieve, for example, a reduction of a chip area and an improvement of a power efficiency of an arithmetic processing unit for the deep learning, using an operation by a fixed point number without using a floating point number may be taken into consideration. This is because a circuit configuration may become simpler by a fixed point operation rather than a floating point number operation.

FIG. 4 exemplifies a configuration of bits used for data expression. Similarly to a 32 bit floating point number, a 16-bit fixed point number, and a 8-bit fixed point number, it is possible to reduce an amount of data to be handled in the multilayered neural network by reducing a bit width used for data expression in data (weights and parameters) to be processed by the deep learning. When the amount of data to be handled is reduced, it is expected that the throughput of the deep learning is reduced, and a learning time is shortened.

However, since a dynamic range of possible values of a fixed point number is narrow, an operational accuracy is deteriorated as compared to that of a floating point number in some cases. FIG. 5 exemplifies a modeled relationship between processings by a 32 bit floating point number, a 16-bit fixed point number, and a 8-bit fixed point number, and the accuracy of inference. In the drawing, a “fixed point number” is described as an “integer.” The fixed point number is not limited to an integer. The fixed point number may also be understood as a binary integer, and thus, in the present specification, the fixed point number is referred to as an integer in some cases. As in the drawing, it is expected that when a bit width is reduced, an operational accuracy is lowered. When the operational accuracy is lowered, the deep learning may not be properly implemented in some cases. That is, in the deep learning, product-sum operations may be repeated many times in forward and backward directions, and as a result, an operation result may exceed the dynamic range of the fixed point number in some cases. Therefore, it is desired to overcome the above described problem caused by reduction of a bit width, through a technique of improving the operational accuracy. Thus, a technique has been suggested in which the fixed point number is expanded.

For example, in a processing by a mixed fixed point, a unified decimal point position is not used for an entire program, but a decimal point position (Q format) suitable for each variable is used. As the Q format, for example, a Q3.12 format defines data of 16 bits including 1 digit for a sign bit, 3 digits for an integer part, and 12 digits below a decimal point. In the mixed fixed point, it is possible to perform a processing by varying a decimal point position for each variable, that is, digits of an integer part and digits below a decimal point.

In another example, in a processing by a dynamic fixed point (a dynamic fixed point number), a value range of a variable is acquired during execution, and a decimal point position is reviewed at a fixed timing. Accordingly, it may be said that in the mixed fixed point operation and the dynamic fixed point operation, aspects of the floating point operation are added to the fixed point operation that has a simple processing as compared to the floating point operation.

Also, there has been proposed a digital signal processor (DSP) that has a function for a program for executing a processing by a mixed fixed point operation and a dynamic fixed point operation. For example, there is a DSP that executes an operation instruction with a block⋅shift designation. In the operation instruction with a block⋅shift designation, an operation is executed with a bit width larger than a bit width of a variable, and a value from an operation result is shifted, cut out, and stored in a register for the variable. By this instruction, a shift amount S (e.g., −128 to 127) when the value is cut out from the operation result may be designated by an immediate value/general-purpose register. For example, when the DSP executes an instruction of Result=Saturate(((in1(operator)in2)>>S), 16), the operation result is shifted by S bits, and higher-order bits are saturated while lower-order 16 bits are left. When S≥0, the DSP arithmetically shifts the operation result to the right (that is, embeds a sign bit and shifts the operation result to the right), and then removes the lower-order bits. Meanwhile, when S<0, the DSP arithmetically shifts the operation result to the left (that is, maintains a sign bit and shifts the operation result to the left), and removes the lower-order bits in the complement.

Also, there has been proposed a DSP that executes a block count leading sign (BCLS) output. The BCLS output is a function by which the DSP takes a count leading sign of an operation result, and writes the result in a register. Here, the count leading sign refers to the most significant position of bit 1 with a positive number (the most significant position of bit 0 with a negative number). For example, when the DSP executes max(block_count_leading_sign(in1(operator)in2)−1), from an operation result by operators of variables in1 and in2, the most significant position of bit 1 with a positive number (the most significant position of bit 0 with a negative number) is written in a register.

In a processing by a dynamic fixed point number according to Non-Patent Literature 1, a presence or absence of overflow is recorded for each operation or variable assignment, and a rate of overflow (e.g., the number of times of overflowing operation with respect to the total number of times of operation and the number of times of overflowing assignment with respect to the total number of times of assignment) is calculated. Then, in this processing, for each predetermined period, a decimal point position of each variable is changed by the following procedures 1 and 2.

(Procedure 1) when the rate of overflow is larger than a prescribed value (rₘₐₓ), a decimal point position is moved to left by one.

(Procedure 2) when the value that is twice the rate of overflow is equal to or less than a prescribed value (rₘₐₓ), a decimal point position is moved to right by one.

Related techniques are disclosed in, for example, Japanese Laid-open Patent Publication No. 07-084975. Related techniques are also disclosed in, for example, Courbariaux et al., “TRAINING DEEP NEURAL NETWORKS WITH LOW PRECISION MULTIPLICATIONS” accepted as a workshop contribution at ICLR 2015, International Conference on Learning Representations (ICLR), Sep. 23, 2015 (Non-Patent Literature 1).

### SUMMARY

According to an aspect of the embodiments, an information processing apparatus includes a memory and a processor coupled to the memory. The processor acquires statistical information including a distribution of operation result values from the memory, when it is determined that a number of acquired statistical information samples is larger than a predetermined value, generates a program by setting a data type for which a ratio of a maximum value to a minimum value of values that can be expressed is smaller among data types usable for target data in an operation as the target data, and when it is determined that the number of acquired statistical information samples is smaller than the predetermined value, generates the program by setting the data type for which the ratio of the maximum value to the minimum value of values that can be expressed is larger among data types usable for target data in the operation as the target data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view exemplifying a configuration of a neural network;

FIG. 2 is a view exemplifying a processing of a convolution operation in the neural network;

FIG. 3 is a view exemplifying a processing of a full connect operation;

FIG. 4 is a view exemplifying a configuration of bits used for data expression;

FIG. 5 is a view exemplifying a modeled relationship between processings by a 32-bit floating point number, a 16-bit fixed point number, and a 8-bit fixed point number, and the accuracy of inference;

FIG. 6 is a view exemplifying distribution data of positions of most significant bit at which value is not the same to the sign bit;

FIG. 7 is a view exemplifying a configuration of a processor;

FIG. 8 is a view exemplifying a circuit block of the processor;

FIG. 9 is a view exemplifying details of a vector unit;

FIG. 10 is a view exemplifying a configuration of a scalar unit;

FIG. 11 is a view exemplifying a truth table of a statistical information acquisition circuit that detects a position of most significant bit at which value is not the same to the sign bit;

FIG. 12 is a view exemplifying a configuration of a hardware circuit of the statistical information acquisition circuit that acquires a position of most significant bit at which value is not the same to the sign bit;

FIG. 13 is a view exemplifying a truth table of a statistical information acquisition circuit that detects a position of least significant bit at which value is not the same to the sign bit;

FIG. 14 is a view exemplifying a configuration of a hardware circuit of the statistical information acquisition circuit that acquires a position of least significant bit at which value is not the same to the sign bit;

FIG. 15 is a view exemplifying a processing of a statistical information aggregating circuit;

FIG. 16 is a view exemplifying a configuration of a hardware circuit of the statistical information aggregating circuit;

FIG. 17 is a view exemplifying a processing of a statistical information aggregating circuit;

FIG. 18 is a view exemplifying a configuration of a hardware circuit of the statistical information aggregating circuit;

FIG. 19 is an example of a specific configuration of the statistical information aggregating circuit;

FIG. 20 is a view exemplifying a configuration of a hardware circuit of a statistical information storage circuit;

FIG. 21 is a view exemplifying a configuration of a hardware circuit of a statistical information storage circuit;

FIG. 22 is an example of a result of learning by a learning network;

FIG. 23 is a view exemplifying a configuration of an information processing system according to a second embodiment;

FIG. 24 is a view exemplifying a configuration of modules when deep learning is executed;

FIG. 25 is a view exemplifying a configuration of a host machine;

FIG. 26 is a view exemplifying a configuration of a DL execution hardware;

FIG. 27 is a view exemplifying a configuration of a DL execution processor;

FIG. 28 is a view exemplifying a logical configuration of the host machine in relation to a program generation;

FIG. 29 is a view exemplifying a template;

FIG. 30 is a view exemplifying a configuration of neural network description data;

FIG. 31 is a view exemplifying definitions of top and bottom in a prototext;

FIG. 32 is a view exemplifying definition of input data of a neural network;

FIG. 33 is a view exemplifying definition of a convolution layer of a neural network;

FIG. 34 is a view exemplifying definition of a full connect layer of a neural network;

FIG. 35 is a view exemplifying a simplified flow of a program generation in the second embodiment;

FIG. 36 is a view exemplifying a threshold value determination processing;

FIG. 37 is a view exemplifying a first modification of the threshold value determination processing;

FIG. 38 is a view exemplifying a second modification of the threshold value determination processing;

FIG. 39 is a view exemplifying a program generation processing;

FIG. 40 is a view exemplifying details of a processing of a variable type determination circuit;

FIG. 41 is a view exemplifying a processing of a program generation circuit;

FIG. 42 is a view exemplifying a processing of setting a type conversion parameter according to a type;

FIG. 43 is a view exemplifying setting of a shift width;

FIG. 44 is a view exemplifying a processing of determining the most significant bit position;

FIG. 45 is a view exemplifying a method of determining scale factors; and

FIG. 46 is a view exemplifying recognition results.

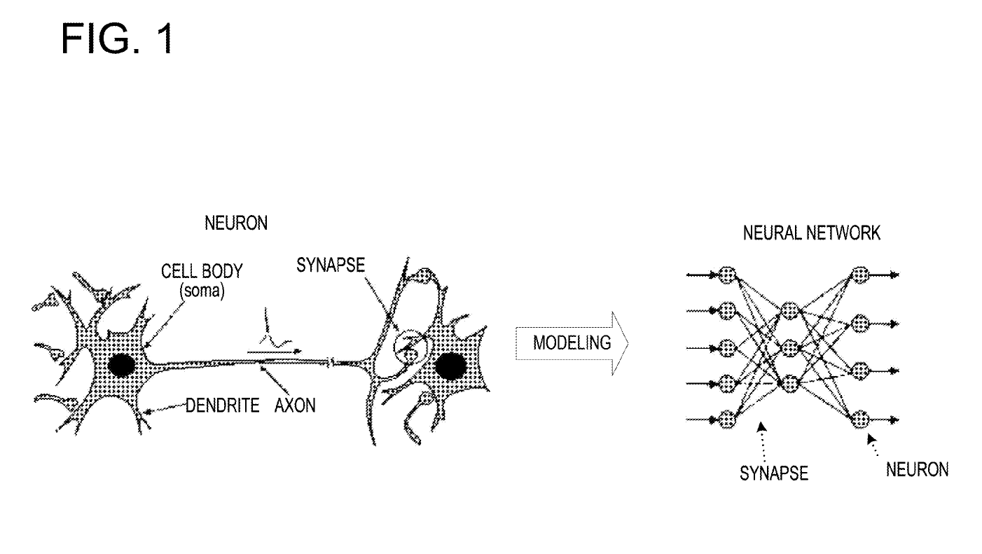

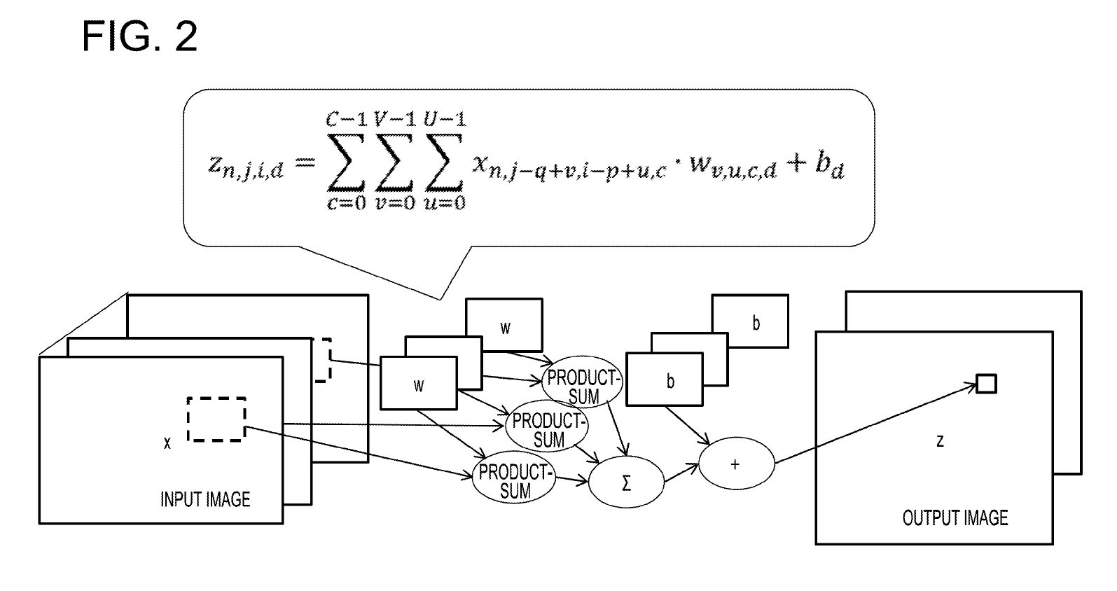

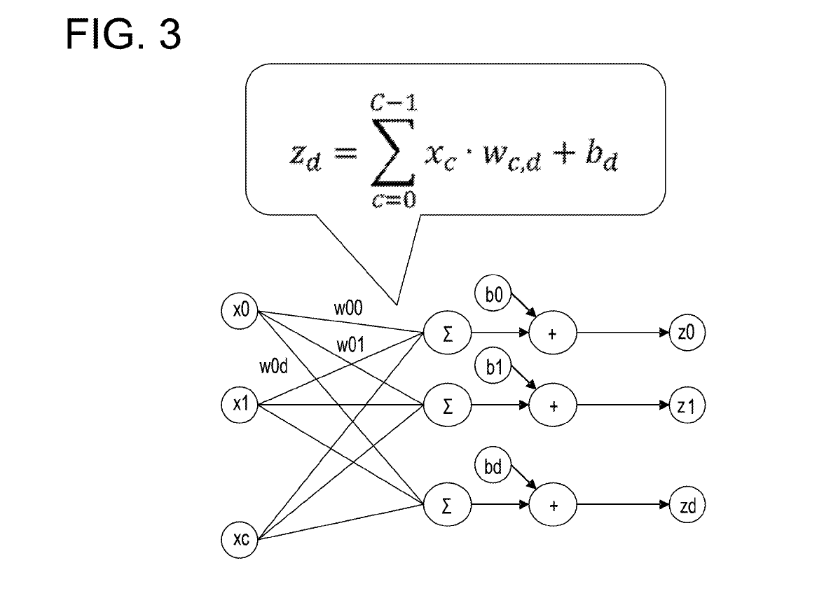

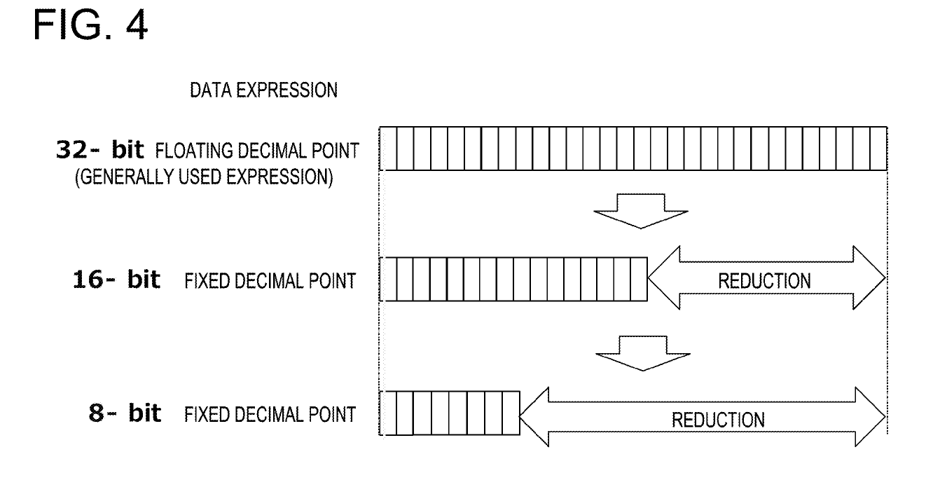

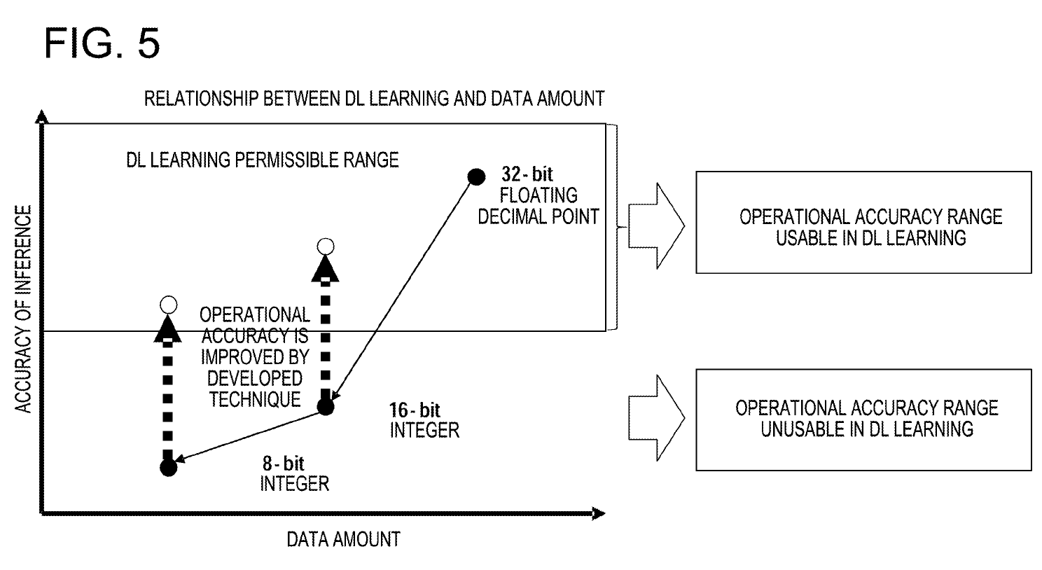

### DESCRIPTION OF EMBODIMENTS

In the related art described above, since a decimal point position is adjusted bit by bit based on a rate of overflow, learning accuracy is deteriorated. For example, in a case where for each learning of k data pieces, a decimal point position is adjusted, when the decimal point position is shifted from a proper position by n bits, learning progresses (n*k) times until the decimal point position is adjusted to the proper position. As a result, an amount of data to be saturated or data to underflow increases until the decimal point position is placed at the proper position, so that the learning may not converge, or the learning accuracy may be deteriorated.

Hereinafter, descriptions will be made on an information processing apparatus according to an embodiment, with reference to the accompanying drawings. The following configuration of the embodiment is exemplary, and the present information processing apparatus is not limited by the configuration of the embodiment.

### First Embodiment

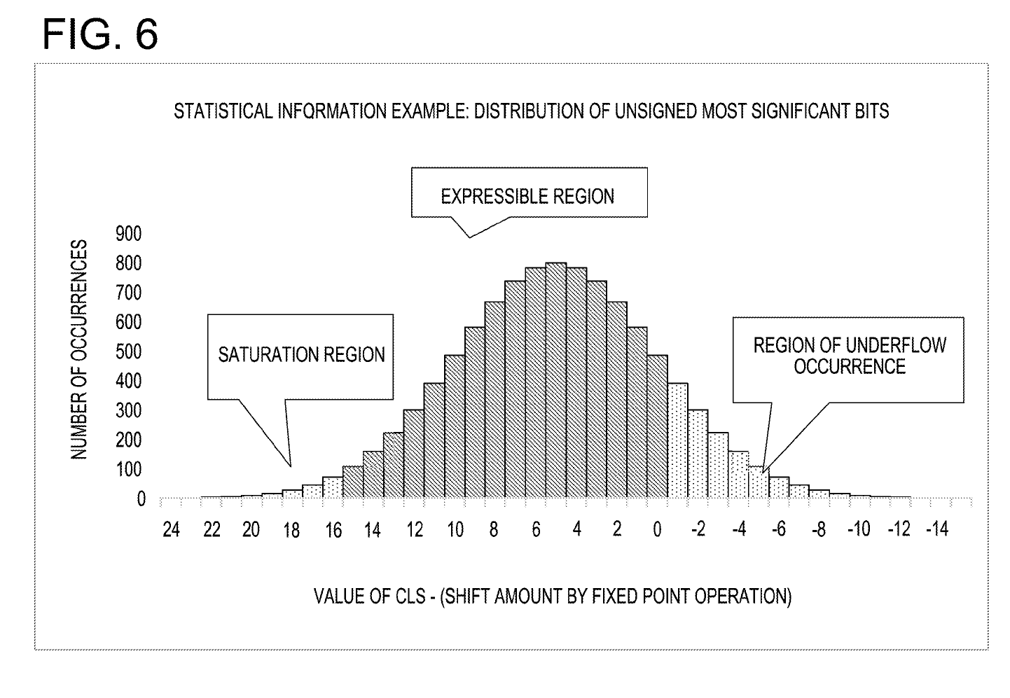

Hereinafter, descriptions will be made on an information processing apparatus 1 according to a first embodiment, an information processing method executed by the information processing apparatus 1, and a program executed in the information processing apparatus 1, with reference to FIGS. 6 to 21. The present embodiment is exemplary, and the information processing apparatus 1 is not limited by the configuration of the present embodiment.

<Statistical Information>

In the present embodiment, a processor of the information processing apparatus 1 acquires statistical information, thereby reducing overhead in a program for acquiring the statistical information. Here, the statistical information acquired by the processor refers to, for example, any one of the followings, or a combination thereof. An application program executed by the information processing apparatus 1 acquires the statistical information from the processor so as to optimize a decimal point position. According to the processing of the application program, the processor executes an instruction for a dynamic fixed point operation.

(1) Distribution of Positions of Most Significant Bit at which Value is not the Same to the Sign Bit

FIG. 6 exemplifies distribution data of positions of most significant bit at which value is not the same to the sign bit. FIG. 6 corresponds to an example on data shifted to the right by 14 bits for the purpose of a digit alignment of a fixed point number, in which an intermediate result of an operation is 40 bits. The position of most significant bit at which value is not the same to the sign bit refers to the most significant bit position where the bit is 1 for a positive number, and refers to the most significant bit position where the bit is 0 for a negative number. The position of most significant bit at which value is not the same to the sign bit indicates, for example, a bit position having the largest index k among bits[k] different from bit[39] (a sign bit) when bits are arranged from bit[39] as the most significant bit, to bit[0] as the least significant bit. When a distribution of the positions of most significant bit at which value is not the same to the sign bit is obtained, it becomes possible to grasp a distribution range of values as absolute values. It can be said that the statistical information includes a distribution of values of an operation result.

In FIG. 6, the vertical axis indicates the number of occurrences of a position of most significant bit at which value is not the same to the sign bit, and the horizontal axis indicates a position count leading sign (CLS) of the most significant bit. In FIG. 6, it is assumed that there is a decimal point on the right side of bit 0. In the present embodiment, an arithmetic circuit of the processor of the information processing apparatus 1 and a register within the arithmetic circuit have a bit width (e.g., 40 bits) equal to or greater than the number of bits (e.g., 16 bits) of a register specified by an operand of an instruction. Meanwhile, the bit width of the arithmetic circuit of the processor of the information processing apparatus 1 and the register within the arithmetic circuit is not limited to 40 bits. The operation result is stored in a register (a register specified by an operand of an instruction) having a smaller bit width than the arithmetic circuit such as a register of 16 bits. As a result, the operation result (e.g., 40 bits) is shifted by a shift amount specified by the operand. Then, bits corresponding to the bits less than bit 0 are subjected to a predetermined rounding processing, and data (data exceeding bit 15) exceeding the bit width of the register specified by the operand is saturated.

Numerical values given to the horizontal axis in FIG. 6 indicate numerical values that may be represented by a fixed decimal point. For example, when the information processing apparatus 1 shifts the fixed point number by −2 bits (shifts to the right by 2 bits), the most significant bit shifts to a position of 14. Then, a region to be saturated is extended by 2 bits, and a region which becomes 0 by occurrence of an underflow is reduced by 2 bits. That is, when the information processing apparatus 1 shifts a decimal point position to the left by 2 bits, the region to be saturated is extended by 2 bits, and the region in which an underflow occurs is reduced by 2 bits. For example, when the information processing apparatus shifts the fixed point number by 2 bits in the positive direction (shifts to the left by 2 bits), the most significant bit shifts to a position of 18. Then, a region to be saturated is reduced by 2 bits, and a region where an underflow occurs is extended by 2 bits. That is, when the information processing apparatus 1 shifts a decimal point position to the right by 2 bits, the region to be saturated is reduced by 2 bits, and the region in which an underflow occurs is extended by 2 bits.

The information processing apparatus 1 may obtain a distribution of positions of most significant bit at which value is not the same to the sign bit during learning execution, so as to immediately determine a proper shift amount in a dynamic fixed point operation, that is, a proper fixed decimal point position. For example, the information processing apparatus 1 may determine the fixed decimal point position such that a ratio of data to be saturated becomes a specified ratio or less. That is, in an example, the information processing apparatus 1 may determine the fixed decimal point position by prioritizing that data is saturated to a predetermined extent rather than that an underflow of data occurs to a predetermined extent.

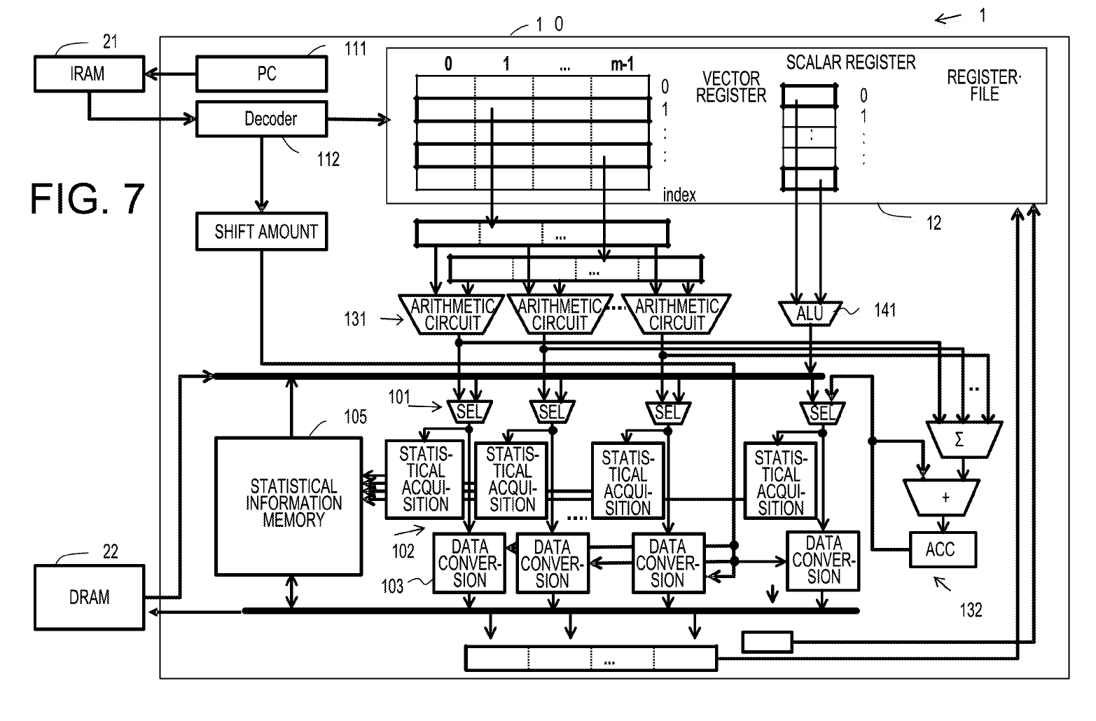

The distribution of the positions of most significant bit at which value is not the same to the sign bit is accumulated within a predetermined register (also referred to as a statistical information register) within a processor 10 of the information processing apparatus 1 (see FIG. 7). The processor 10 executes commands such as reading and writing of distribution data from/to the corresponding statistical information register, and clearing of the statistical information register. Thus, in the statistical information register, distribution data on one or more fixed point numbers that become command execution targets from the time of execution of a previous-time clear command to the present time is accumulated. The accumulated distribution data is read to a memory by a read command. The processor 10 may execute a command to perform loading into the statistical information register instead of the clear command, so that a value 0 may be loaded in the statistical information register.

(2) Distribution of Positions of Least Significant Bit at which Value is not the Same to the Sign Bit

The distribution of positions of least significant bit at which value is not the same to the sign bit indicates the least significant bit position where a bit has a value different from a sign. For example, the least significant bit position indicates a bit position having the smallest index k among bits[k] different from bit[39] (a sign bit) when bits are arranged from bit[39] as the most significant bit to bit[0] as the least significant bit. In the distribution of the positions of least significant bit at which value is not the same to the sign bit, least significant bits including valid data are grasped.

(3) Maximum Value of Positions of Most Significant Bit at which Value is not the Same to the Sign Bit

A maximum value of positions of most significant bit at which value is not the same to the sign bit is the maximum value among most significant bit positions having values different from a value of a sign bit with respect to one or more fixed point numbers that become command execution targets from the time of execution of a previous-time clear command to the present time. The information processing apparatus 1 may use the maximum value of the positions of most significant bit at which value is not the same to the sign bit in determining a proper shift amount in a dynamic fixed point operation, that is, a proper decimal point position.

The processor executes commands such as reading of the maximum value from the statistical information register, and clearing of the statistical information register. Therefore, in the statistical information register, maximum values from the execution of the previous-time clear command to the present time are accumulated, and the maximum values are read to the memory by a read command.

(4) Minimum Value of Positions of Least Significant Bit at which Value is not the Same to the Sign Bit

A minimum value of positions of least significant bit at which value is not the same to the sign bit is the minimum value among least significant bit positions having different values from a sign with respect to one or more fixed point numbers from the time of execution of a previous-time clear command to the present time. The information processing apparatus 1 may use the minimum value of the positions of least significant bit at which value is not the same to the sign bit in determining a proper shift amount in a dynamic fixed point operation, that is, a proper decimal point position.

The processor 10 executes commands such as reading and clearing of the minimum value from the statistical information register. Accordingly, in the statistical information register, the minimum values from the execution of the previous-time clear command to the present time are accumulated, and then are read to the memory by a read command.

<Configuration>

FIG. 7 exemplifies a configuration of the processor 10 in the information processing apparatus 1. In FIG. 7, together with the processor 10, an instruction memory (IRAM) 21 and a data memory (DRAM) 22 are also exemplified. The processor 10 is a single instruction multiple data (SIMD)-type arithmetic processing unit.

The processor 10 includes the control unit 11 including a program counter (PC) 111 and a decoder 112, a register file 12, a vector operation arithmetic circuit 131, a scalar operation arithmetic circuit (arithmetic logic unit (ALU)) 141, and an accumulator 132 that adds the result of the vector operation arithmetic circuit 131. Further, the processor 10 includes a plurality of selectors 101 that select operation results of the vector operation arithmetic circuit 131, the scalar operation arithmetic circuit 141, the accumulator 132 etc., and read results from the data memory 22. In the drawing, a plurality of selectors are collectively referred to as the selector 101. A plurality of vector operation arithmetic circuits are collectively referred to as the arithmetic circuit 131.

The processor 10 includes a statistical information acquisition circuit 102 that acquires statistical information from data selected by the selector 101, and a statistical information storage circuit 105 that stores the statistical information acquired by the statistical information acquisition circuit 102. The statistical information acquisition circuit 102 and the statistical information storage circuit 105 are examples of an acquisition circuit that acquires statistical information on a distribution of bits in fixed point number data after an instruction is executed for the fixed point number data. In the drawing, a plurality of statistical information acquisition circuits are collectively referred to as the statistical information acquisition circuit 102.

Further, the processor 10 includes a data converting circuit 103 that changes a fixed decimal point position of data selected by the selector 101. In the drawing, a plurality of data converting circuits are collectively referred to as the data converting circuit 103.

As in the drawing, an instruction is fetched from an address of the instruction memory 21 indicated by the program counter 111, and the decoder 112 decodes the fetched instruction. In the drawing, an instruction fetching control circuit that executes fetching of an instruction is omitted.

When the decoder 112 decodes the instruction, respective units of the processor 10 are controlled according to the decoded result. For example, when the decoded result is a vector operation instruction, data in a vector register of the register file 12 is input to the vector operation arithmetic circuit 131, and a vector operation is executed. The operation result of the vector operation arithmetic circuit 131 is supplied to the statistical information acquisition circuit 102 and the data converting circuit 103 through the selector 101. Further, the operation result of the vector operation arithmetic circuit 131 is input to the accumulator 132, and the operation result of the vector operation arithmetic circuit 131 is added to, for example, a cascade. The operation result of the accumulator 132 is supplied to the statistical information acquisition circuit 102 and the data converting circuit 103 through the selector 101.

For example, when, as a result of the decoding, the instruction is a scalar operation instruction, data in a scalar register of the register file 12 is input to the scalar operation arithmetic circuit 141. Similarly to the operation result of the accumulator 132, the operation result of the arithmetic circuit 141 is supplied to the statistical information acquisition circuit 102 and the data converting circuit 103 through the selector 101.

For example, when, as a result of the decoding, the instruction is a load instruction, data is read from the data memory 22, and is supplied to the statistical information acquisition circuit 102 and the data converting circuit 103 through the selector 101. The result obtained through data conversion in the data converting circuit 103 is stored in a register of the register file 12.

When as a result of decoding, the instruction is an instruction to execute a dynamic fixed point operation, the decoder 112 instructs a shift amount to be supplied to the data converting circuit 103. The shift amount is acquired from, for example, an operand (immediate value) of an instruction, a register specified by an operand, and the data memory 22 of an address indicated by an address register specified by an operand and is supplied to the data converting circuit 103. The processing in FIG. 7 is an example in which a decoder acquires specifying (shift amount) of a decimal point position of fixed point number data from an instruction.

The data converting circuit 103 shifts fixed point number data obtained from the result of the vector operation, the result of the scalar operation, the operation result of the accumulator 132, or the result read from the data memory 22 by a specified shift amount S. The data converting circuit 103 executes not only shifting, but also a saturation processing of higher-order bits and a rounding of lower-order bits. The data converting circuit 103 includes a rounding processing circuit that rounds lower-order S bits as a decimal part with respect to, for example, an operation result of 40 bits as input, a shifter that executes arithmetic shifting, and a saturation processing circuit that performs a saturation processing.

The rounding processing circuit rounds lower-order S bits as a decimal part. When S is negative, the rounding processing circuit does not perform anything. As for the rounding, rounding to nearest, rounding to 0, rounding to positive infinity, rounding to negative infinity, and random number rounding are exemplified. The shift amount when the data converting circuit 103 shifts the fixed point number data is a shift amount acquired from the instruction by the decoder, for example, as exemplified in FIG. 7.

The shifter performs an arithmetic shift to the right by S bits when S is positive, and performs an arithmetic shift to the left, that is, an arithmetic left shift by −S bits when S is negative. The saturation processing circuit outputs 2E15 with respect to a shift result equal to or greater than 2E15-1 (positive maximum value), outputs −2E15 with respect to a shift result equal to or less than −2E15 (negative minimum value), or outputs lower-order 16 bits of the input in other cases. Here, 2E15 represents the fifteenth power of 2.

Then, the data converting circuit 103 maintains a sign of higher-order bits at the time of the left shift, and performs a saturation processing on bits other than the sign bit. That is, the data converting circuit 103 discards a higher-order bit, and embeds 0 into a lower-order bit. At the time of the right shift, the data converting circuit 103 embeds a sign bit into a higher-order bit (a bit at a lower order than a sign bit). Then, the data converting circuit 103 outputs data obtained as described above through rounding, shifting, and saturation processing, with the same bit width (e.g., a register of 16 bits) as, for example, a register of the register file 12. The data converting circuit is an example of an update circuit that updates a decimal point position of fixed point number data.

Accordingly, a computer program executed in the processor 10 specifies a shift amount in an operand of an instruction that executes a dynamic fixed point operation so that the processor 10 updates a decimal point position of a fixed point number by the specified shift amount during program execution.

As a result of decoding, when the instruction is an instruction to acquire statistical information (referred to as an instruction with a statistical information acquisition function), the statistical information is acquired by the statistical information acquisition circuit 102, and is stored in the statistical information storage circuit 105. Here, as described above, the statistical information is (1) a distribution of positions of most significant bit at which value is not the same to the sign bit, (2) a distribution of positions of least significant bit at which value is not the same to the sign bit, (3) a maximum value of positions of most significant bit at which value is not the same to the sign bit, (4) a minimum value of positions of least significant bit at which value is not the same to the sign bit, or a combination thereof.

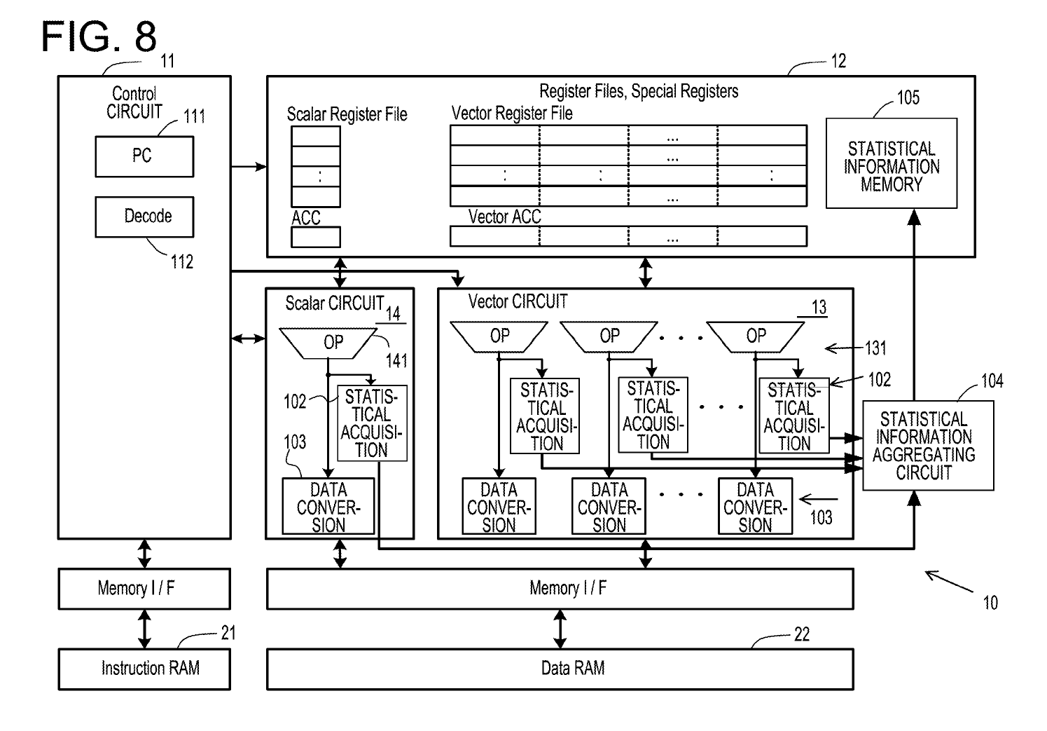

FIG. 8 exemplifies a circuit block of the processor 10 in FIG. 7. The processor 10 includes the control unit 11, the register file 12, a vector unit 13, and a scalar unit 14. The control unit 11 includes the program counter 111 and the decoder 112. The register file includes a vector register file, an accumulator register (Vector ACC) for a vector operation, a scalar register file, and an accumulator register (ACC) for a scalar operation. The vector unit 13 includes the vector operation arithmetic circuit 131, the statistical information acquisition circuit 102, and the data converting circuit 103. The scalar unit 14 includes the scalar operation arithmetic circuit 141, the statistical information acquisition circuit 102, and the data converting circuit 103.

In the configuration example of FIG. 8, a statistical information aggregating circuit 104 that aggregates statistical information from the plurality of statistical information acquisition circuits 102 is added. The statistical information storage circuit 105 is set as a part of the register file 12. The instruction memory 21 is connected to the control unit 11 via a memory interface (memory I/F). The data memory 22 is connected to the vector unit 13 and the scalar unit 14 via the memory interface (memory I/F).

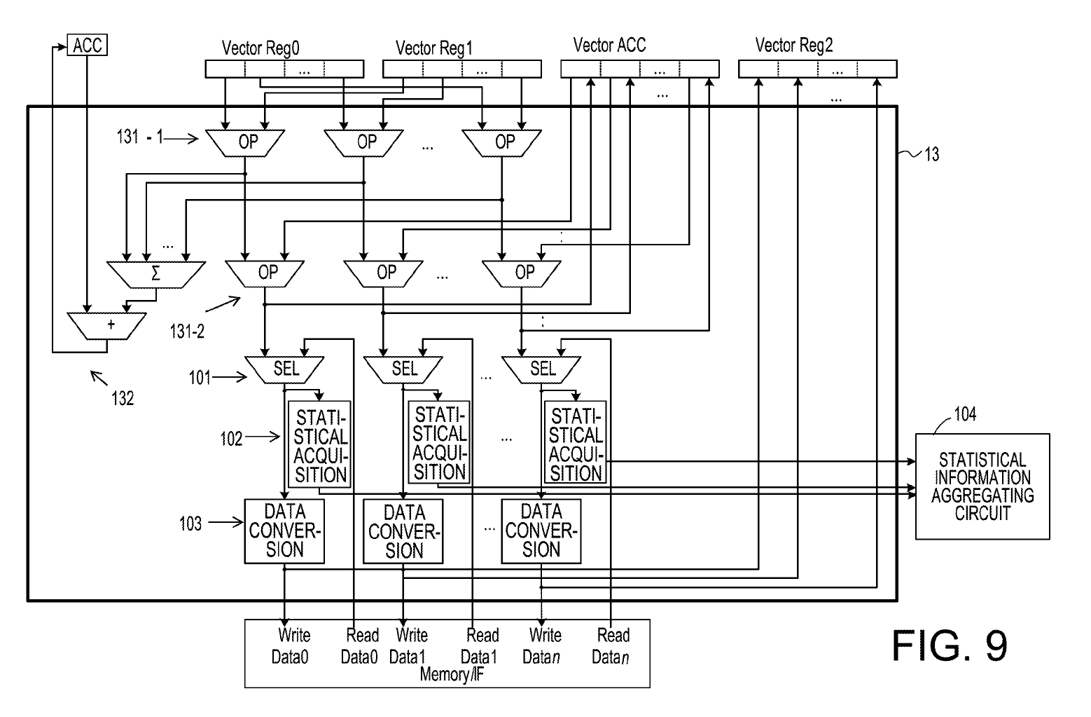

FIG. 9 exemplifies details of the vector unit 13. In the drawing, the statistical information aggregating circuit 104 is also exemplified. The vector unit 13 operates data in vector registers Vector Reg0, and Vector Reg1 by the vector operation arithmetic circuit 131-1. The operation result of the vector operation arithmetic circuit 131-1 is input to the accumulator 132 for a product-sum operation, and the vector operation arithmetic circuit 131-2.

The accumulator 132 for the product-sum operation scalar-adds the operation result of the vector operation arithmetic circuit 131-1, and stores the result in the accumulator register (ACC) for a scalar operation. According to an operation mode specified by the instruction, the vector operation arithmetic circuit 131-2 outputs the operation result of the vector operation arithmetic circuit 131-1, data of the accumulator register (Vector ACC) for a vector operation, or an addition result thereof.

The selector 101 selects either the output result of the vector operation arithmetic circuit 131-2 or the result read from the data memory 22 (Read Data 0, . . . , Read Data 0), and inputs the selected one to the statistical information acquisition circuit 102 and the data converting circuit 103. The statistical information acquired by the statistical information acquisition circuit 102 is input to the statistical information aggregating circuit 104. The data obtained through a data conversion by the data converting circuit 103 is stored in the data memory 22 (Write Data 0, . . . , Write Data n), or held in the vector register (Vector Reg2) via a selector (not illustrated).

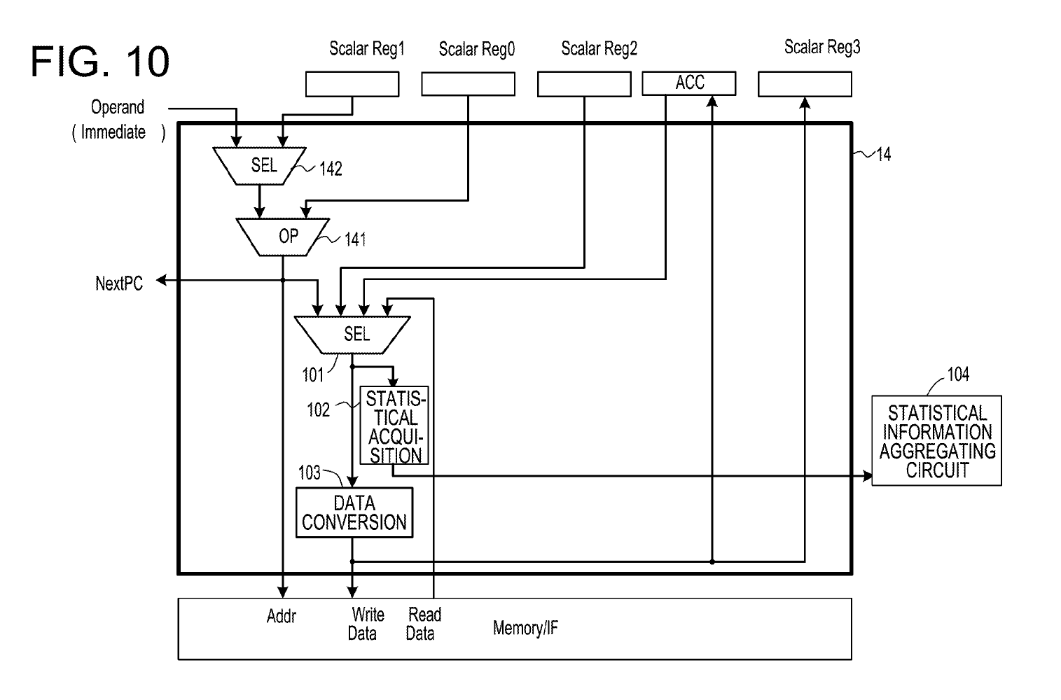

FIG. 10 exemplifies the configuration of the scalar unit 14. The scalar unit 14 includes a selector 142 that selects either data obtained from an immediate operand or data from a scalar register Scalar Reg1, and the scalar arithmetic circuit 141 that operates the selection result of the selector 142 and data of a scalar register Scalar Reg0. The operation result of the scalar arithmetic circuit 141 is stored in an address (e.g., Addr) of the data memory 22 via the memory interface (memory I/F). The operation result of the scalar arithmetic circuit 141 is input to the statistical information acquisition circuit 102 and the data converting circuit 103 via the selector 101.

The selector 101 selects any one of the operation result of the scalar arithmetic circuit 141, data of a scalar register Scalar Reg2, data of the accumulator register (ACC) for a scalar operation, and data (Read Data) read through the memory interface (Memory I/F). The selector 101 inputs the selected data to the statistical information acquisition circuit 102 and the data converting circuit 103. The statistical information acquisition circuit 102 acquires statistical information from data input from the selector 101, and inputs the acquired statistical information to the statistical information aggregating circuit 104.

Hereinafter, among the statistical information acquisition circuits 102, one that acquires a position of most significant bit at which value is not the same to the sign bit will be referred to as a statistical information acquisition circuit 102A. Among the statistical information acquisition circuits 102, the one that acquires a position of least significant bit at which value is not the same to the sign bit will be referred to as a statistical information acquisition circuit 102B. Among the statistical information aggregating circuits 104, the one that counts bit positions acquired by the statistical information acquisition circuit 102 and acquires a bit distribution with respect to the bit positions will be referred to as a statistical information aggregating circuit 104A. Among the statistical information aggregating circuits 104, the one that performs an OR operation of bit positions acquired by the statistical information acquisition circuit 102 in a preliminary step of acquiring a maximum value and a minimum value of the bit positions will be referred to as a statistical information aggregating circuit 104B.

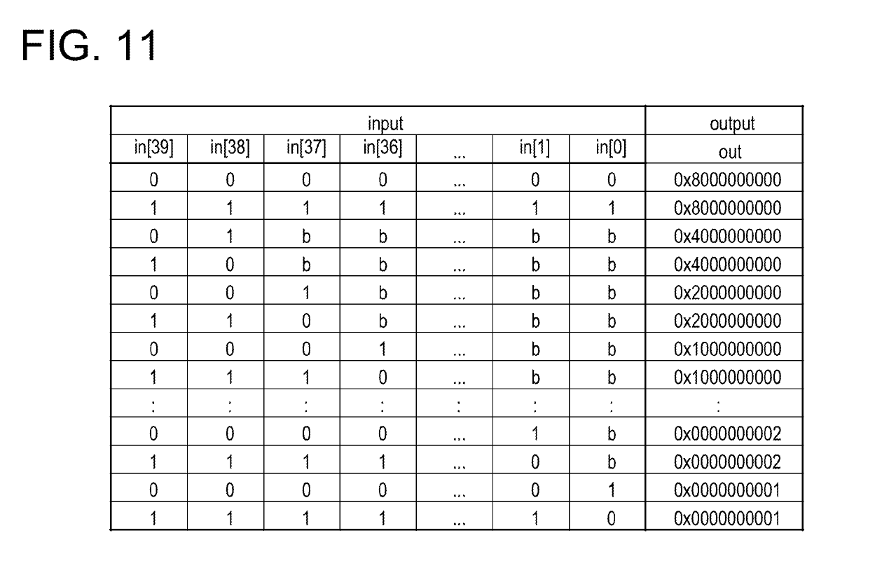

FIG. 11 exemplifies a truth table of the statistical information acquisition circuit 102A that detects a position of most significant bit at which value is not the same to the sign bit. As in FIG. 11, the statistical information acquisition circuit 102A outputs a binary bit pattern in which a position of a bit that firstly becomes 1 is set to 1, and other bits are set to 0, through a search on bits in a direction from bit in[38] toward the lower-order bit, for a positive number. The statistical information acquisition circuit 102A outputs a binary bit pattern in which a position of a bit that firstly becomes 0 is set to 1, and other bits are set to 0, through a search on bits in a direction from in[38] toward the lower-order bit, for a negative number. When all bits of input data are 0 or 1, the statistical information acquisition circuit 102A outputs 1 to 39^{th} bit, and 0 to 38^{th} or lower bits.

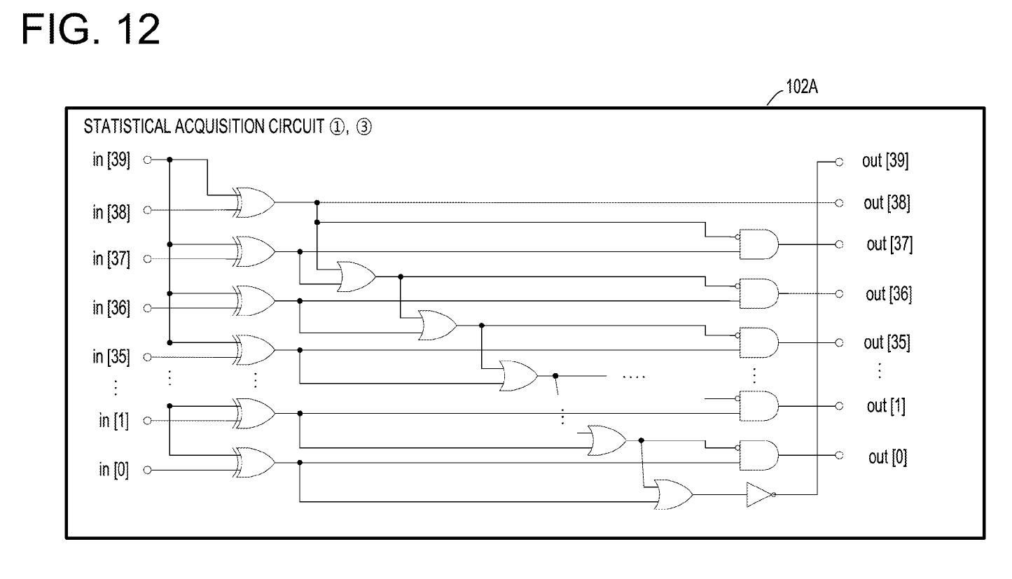

FIG. 12 exemplifies a configuration of a hardware circuit in the statistical information acquisition circuit 102A that acquires a position of most significant bit at which value is not the same to the sign bit. In this circuit, exclusive OR (EXOR) between the sign bit in[39] and other bits (in[38] to in[0]) is executed. Then, the exclusive OR value by a bit having the same value as the sign bit in[39] becomes 0, and the exclusive OR value by a bit having a different value from the sign bit in[39] becomes 1.

Here, for example, when in[38] and in[39] have different values, out[38] of output data becomes 1 by exclusive OR. Meanwhile, the exclusive OR value of in[39] and in[37] is input to out[37] of the output data via an AND gate. To one input of the AND gate, a bit value obtained by inverting the exclusive OR value of in[39] and in[38] is input. Thus, when in[39] does not match in[38], regardless of the exclusive OR value of in[39] and in[37], the output of the AND gate becomes 0.

Hereinafter, in a similar situation, the input with logical NOT of the AND gate from which out[i] (i is 37 or less) is output becomes 0 when all the exclusive ORs of in[39] and in[j] (j is i+1 or more, and 38 or less) are 0. When the exclusive OR value of in[39] and in[i] (i is 37 or less) becomes 1, 1 is set to out[i]. For the bits at lower orders than the corresponding bit position (i), the input with logical NOT of the AND gate from which out[i] is output becomes 1, and thus 0 is set to out[i]. Accordingly, by the circuit of FIG. 12, output data out (40 bits) is acquired in which 1 is set to the position of most significant bit at which value is not the same to the sign bit, and 0 is set to other bits. The statistical information acquisition circuit 102A that acquires the position of most significant bit at which value is not the same to the sign bit as in FIGS. 11 and 12 is an example of a circuit that acquires a position of the most significant bit not matching a sign bit in fixed point number data after instruction execution. The output data out (40 bits) in which 1 is set to the position of most significant bit at which value is not the same to the sign bit, and 0 is set to other bits is an example of a bit string that indicates the position of the most significant bit not matching the sign bit, with a true value (1).

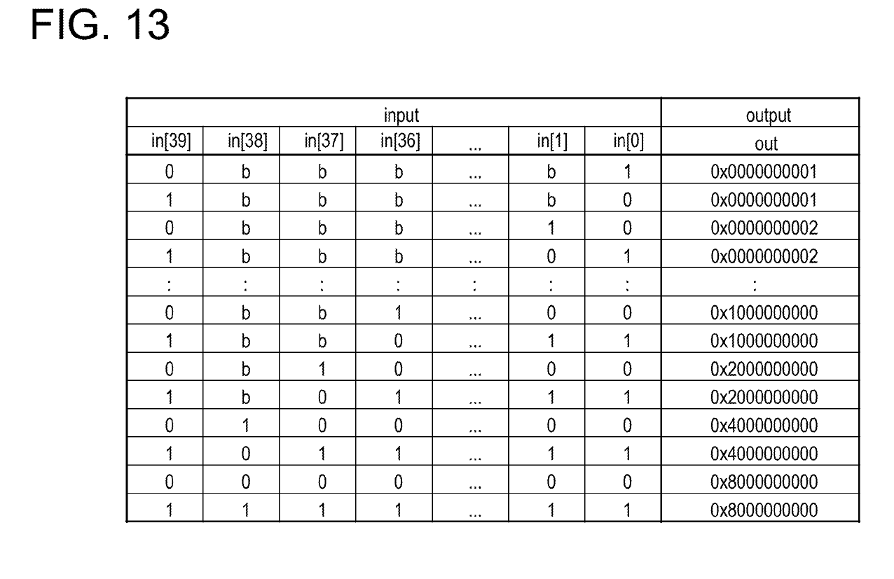

FIG. 13 exemplifies a truth table of the statistical information acquisition circuit 102B that detects a position of least significant bit at which value is not the same to the sign bit. As in FIG. 13, the statistical information acquisition circuit 102B outputs a binary bit pattern in which a position of a bit that becomes 1 for the first time is set to 1, and other bits are set to 0, through a search on bits in a direction from in[0] toward the higher-order bit, for a positive number. Further, the statistical information acquisition circuit 102B outputs a binary bit pattern in which a position of a bit that becomes 0 for the first time is set to 1, and other bits are set to 0, through a search on bits in a direction from in[0] toward the higher-order bit, for a negative number. When all bits of input data are 0 or 1, the statistical information acquisition circuit 102B outputs 1 to 39th bit, and 0 to 38th or lower bits.

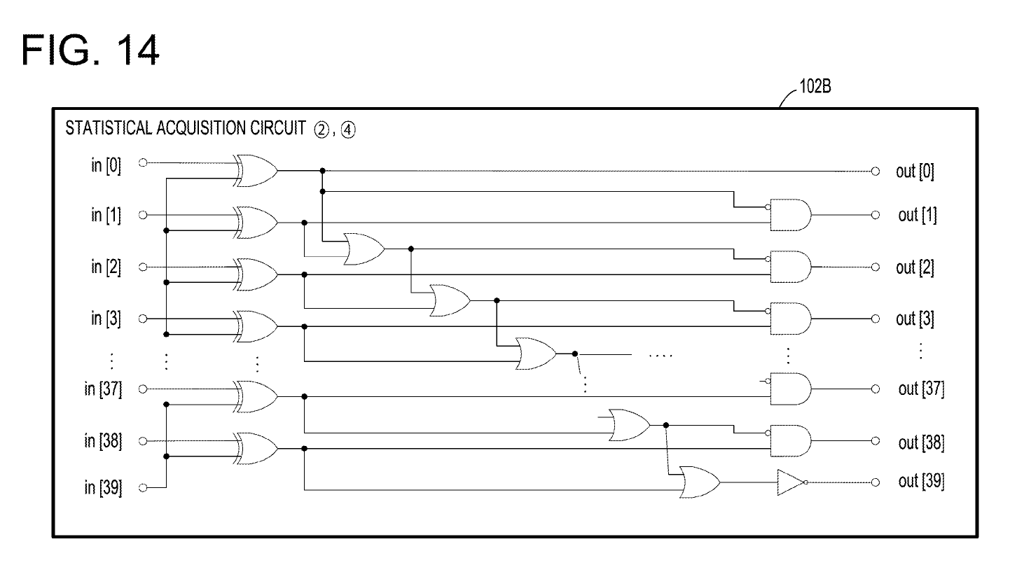

FIG. 14 exemplifies a configuration of a hardware circuit in the statistical information acquisition circuit 102B that acquires a position of least significant bit at which value is not the same to the sign bit. When the sign bit in[39] is 0, the statistical information acquisition circuit 102B may search for a bit position where the bit is 1 from the least significant bit in[0] toward the higher-order side. Meanwhile, when the sign bit in[39] is 1, since data is complementary, the statistical information acquisition circuit 102B may search for a bit position where the bit is 0 from the least significant bit in[0] toward the higher-order side.

That is, in this circuit, exclusive OR (EXOR) between the sign bit in[39] and other bits (in[0] to in[38]) is executed. Then, the exclusive OR value by a bit having the same value as the sign bit in[39] becomes 0, and the exclusive OR value by a bit having a different value from the sign bit in[39] becomes 1.

Here, for example, when in[0] and in[39] have different values, out[0] of output data becomes 1 by exclusive OR. Meanwhile, the exclusive OR value of in[39] and in[1] is input to out[1] of the output data via an AND gate. To one input of the AND gate, a bit value obtained by inverting the exclusive OR value of in[39] and in[0] is input. Thus, when the exclusive OR value of in[39] and in[0] is 1, regardless of the exclusive OR value of in[39] and in[1], the output of the AND gate becomes 0.

Hereinafter, in a similar situation, the input with logical NOT of the AND gate from which out[i] (i is 1 or more) is output becomes 0 when all the exclusive ORs of in[39] and in[j] (j is 0 or more, and i−1 or less) are 0. When the exclusive OR value of in[39] and in[i] (i is 1 or more) becomes 1, 1 is set to out[i]. To the output data out[i] at a higher order than the corresponding bit, 0 is set. Accordingly, by the circuit of FIG. 14, output data out (40 bits) is acquired in which 1 is set to the position of least significant bit at which value is not the same to the sign bit, and 0 is set to other bits. The statistical information acquisition circuit 102B that acquires the position of least significant bit at which value is not the same to the sign bit as in FIGS. 13 and 14 is an example of a circuit that acquires the least significant bit position not matching a sign bit. The output data out (40 bits) in which 1 is set to the position of least significant bit at which value is not the same to the sign bit, and 0 is set to other bits is an example of a bit string that indicates the position of the least significant bit not matching the sign bit, with a true value (1).

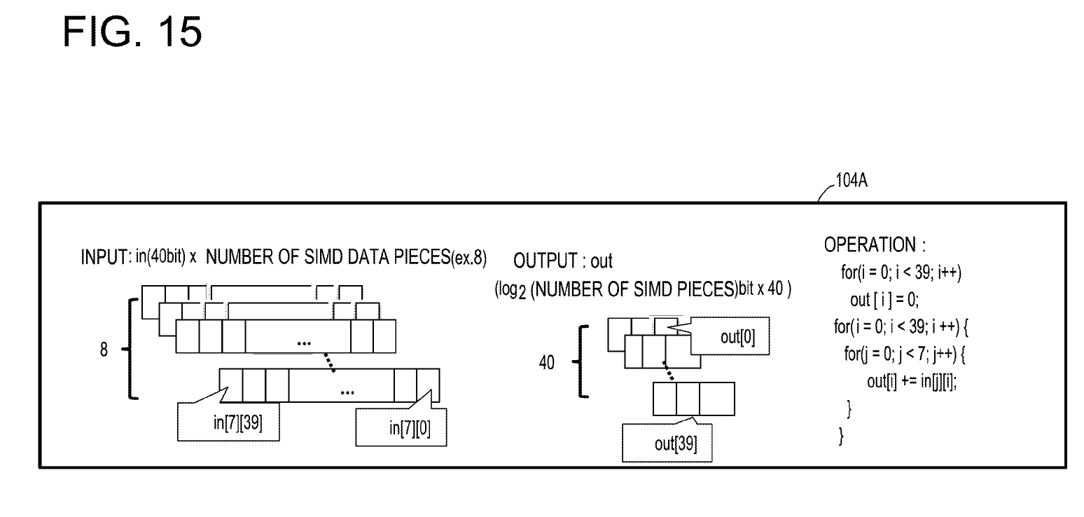

FIG. 15 is a view exemplifying a processing of the statistical information aggregating circuit 104A that acquires a distribution of bits from data acquired by the statistical information acquisition circuit 102. In the drawing, a processing of acquiring a distribution of bits from SIMD data in which eight pieces of 40-bit data are processed in parallel is exemplified. In FIG. 15, a processing of the statistical information aggregating circuit 104A which is a hardware circuit is described in pseudo code.

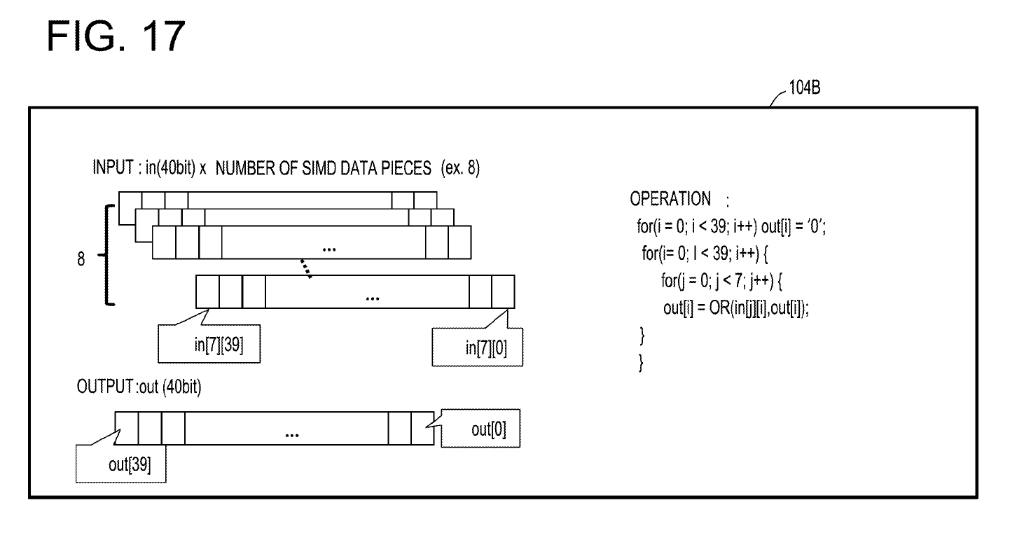

That is, input data is exemplified as array data of 8 (rows)×40 (bits). The input data of 40 bits in each row is data of a position of most significant bit at which value is not the same to the sign bit (output of the statistical information acquisition circuit 102A in FIG. 12) or a position of least significant bit at which value is not the same to the sign bit (output of the statistical information acquisition circuit 102B in FIG. 14). In this processing, with respect to 40-bit output data out, first, all the bits are cleared. Then, values of elements of each column i in the array in[j][i] of the input data are added with respect to all the rows (j=0 to 7). Therefore, unlike in FIGS. 11 and 13, in the pseudo code of FIG. 15, the output data (an array element) out[j] is an integer of log₂ (the number of SIMD data pieces) bits (3 bits in the example of FIG. 15). In FIG. 17, it is assumed that the number of SIMD data pieces (the number of data pieces processed in parallel) is 8, but the number of SIMD data pieces is not limited to 8.

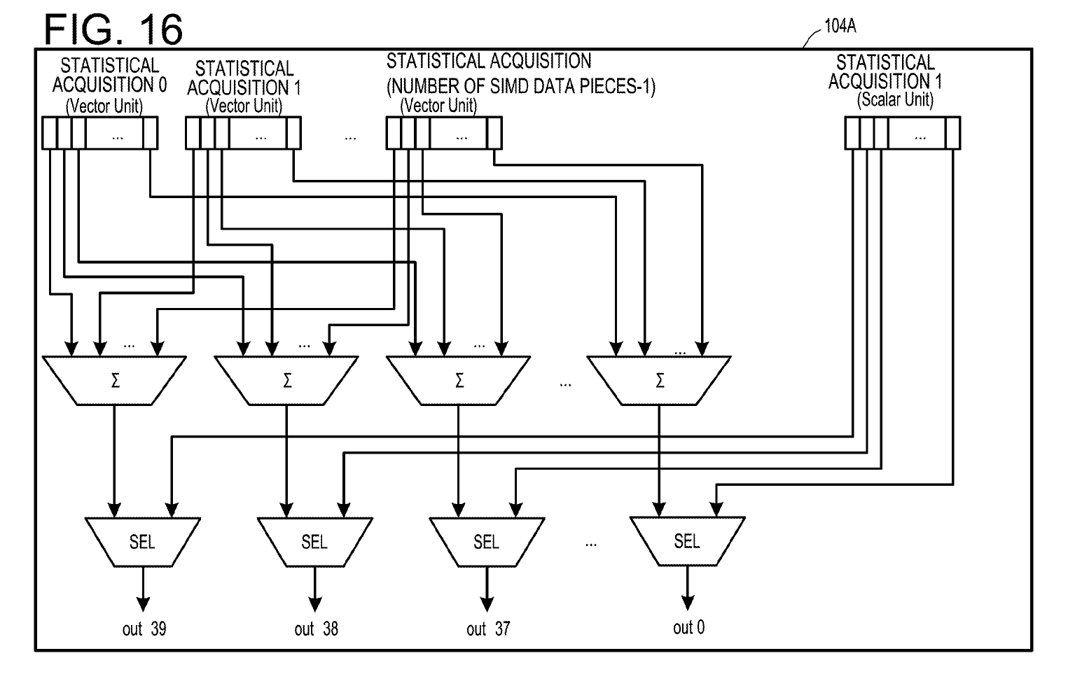

FIG. 16 exemplifies a configuration of a hardware circuit of the statistical information aggregating circuit 104A that acquires a distribution of bits from data acquired by the statistical information acquisition circuit 102. By a bit population count operation on data acquired by the statistical information acquisition circuit 102 (here, statistics acquisition, the number of SIMD data pieces −1, from statistics acquisition, 0), the number of 1's is counted at i^{th} bits (i=0 to 39) in eight pieces of statistical information. The input data is a position of most significant bit at which value is not the same to the sign bit acquired by the statistical information acquisition circuit 102A (FIGS. 11 and 12). Accordingly, the statistical information aggregating circuit 104A counts the number of occurrences of ‘1’ at each bit with respect to positions of most significant bit at which value is not the same to the sign bit corresponding to the number of SIMD data pieces acquired by the statistical information acquisition circuit 102A, so as to count the number of occurrences of the most significant bit position. The statistical information aggregating circuit 104A stores the count result in each of output data out0 to out39.

The input data may be set as a position of least significant bit at which value is not the same to the sign bit by the statistical information acquisition circuit 102B (FIGS. 13 and 14). The statistical information aggregating circuit 104A counts the number of occurrences of ‘1’ at each bit with respect to positions of least significant bit at which value is not the same to the sign bit corresponding to the number of SIMD data pieces acquired by the statistical information acquisition circuit 102B so as to count the number of occurrences of the least significant bit position. The statistical information aggregating circuit 104A stores the count result in each of output data out0 to out39. That is, the statistical information aggregating circuit 104A may process either the positions of most significant bit at which value is not the same to the sign bit or the positions of least significant bit at which value is not the same to the sign bit.

In FIG. 16, a selector SEL selects data acquired from a bit population count arithmetic circuit (Σ) and the scalar unit 14. The data selected by the selector SEL is output to output data from out0 to out39. Therefore, data acquired by the statistical information acquisition circuit 102 through the scalar unit 14 is output, as it is, to output data from out0 to out39 without being added in the first time operation of the scalar unit 14. The output data out0 to out39 are data to be delivered to the statistical information storage circuit 105. The statistical information aggregating circuit 104A in FIGS. 15 and 16 is an example of a circuit that accumulates and counts the position of the most significant bit not matching the sign bit with respect to a plurality of fixed point number data pieces. The statistical information aggregating circuit 104A in FIGS. 15 and 16 is also an example of a circuit that accumulates and counts the position of the least significant bit not matching the sign bit with respect to a plurality of fixed point number data pieces.

FIG. 17 is a view exemplifying a processing of the statistical information aggregating circuit 104B that aggregates bit positions by an OR operation, as a precondition for acquiring a maximum value and a minimum value of bit positions from data acquired by the statistical information acquisition circuit 102. Also, in FIG. 17, as in FIG. 15, a processing of acquiring a distribution of bits from SIMD data in which eight pieces of 40-bit data are processed in parallel is exemplified. In FIG. 17, a processing of the statistical information aggregating circuit 104B which is a hardware circuit is described in pseudo code.

In this processing, a result obtained through OR operations of each column in the array in[j][i] of input data, with respect to all rows (j=0, . . . , 7), is input to 40-bit output data out[i] (i=0, . . . , 39). Accordingly, in the pseudo code of FIG. 17, unlike in FIG. 15, the output data (an array element) out[i] (i=0, . . . , 39) is a bit string. As a result of the above processing, in the output data out[i](i=0, . . . , 39), a position of a bit that firstly becomes 1 in a direction from out[38] toward the lower-order bit is the maximum bit position. A position of a bit that firstly becomes 1 in a direction from out[0] toward the higher-order bit is the minimum bit position.

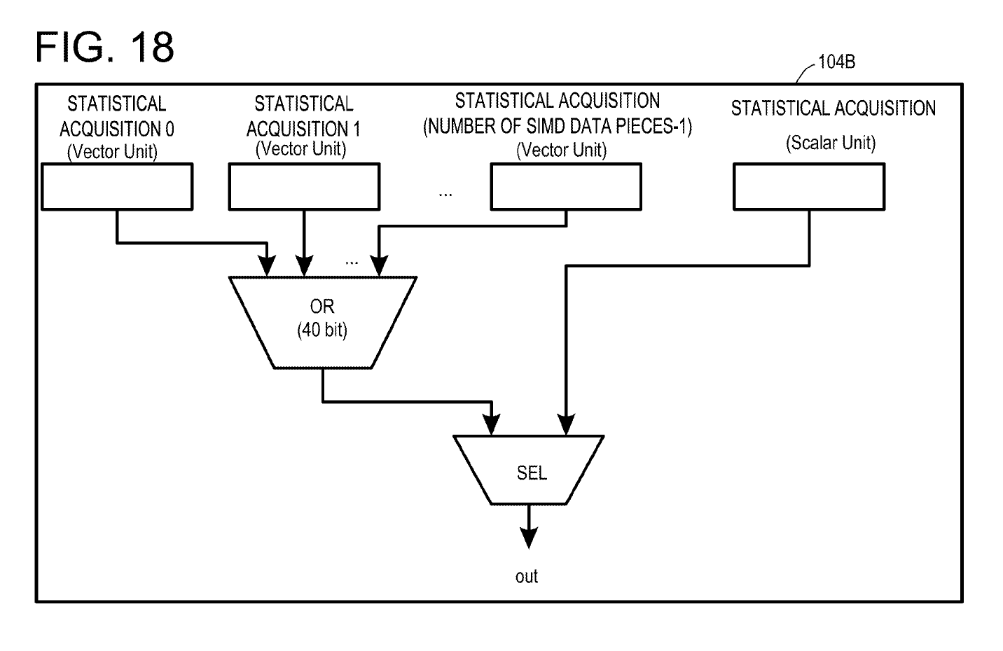

FIG. 18 exemplifies a configuration of a hardware circuit of the statistical information aggregating circuit 104B that aggregates bit positions by an OR operation as a precondition for acquiring a maximum value and a minimum value of bit positions from data acquired by the statistical information acquisition circuit 102. The data acquired by the statistical information acquisition circuit 102 (here, from statistics acquisition, 0, to statistics acquisition, the number of SIMD data pieces −1) is ORed by an OR gate (40 bits). In FIG. 18, the selector SEL selects data acquired from an OR operation (OR) and the scalar unit 14. The data selected by the selector SEL is output to output data out. Therefore, data acquired by the statistical information acquisition circuit 102 through the scalar unit 14 is output, as it is, to output data out without being ORed in the first time operation. The output data out is data to be delivered to the statistical information storage circuit 105.

The statistical information aggregating circuit 104B that aggregates bit positions by an OR operation is an example of a circuit that accumulates a bit string indicating the position of the most significant bit not matching a sign bit, with a true value, by an OR operation with respect to a plurality of fixed point number data pieces. The statistical information aggregating circuit 104B that aggregates bit positions by an OR operation is also an example of a circuit that accumulates a bit string that indicates the position of the least significant bit that does not matching the sign bit, with a true value, by an OR operation with respect to a plurality of fixed point number data pieces.

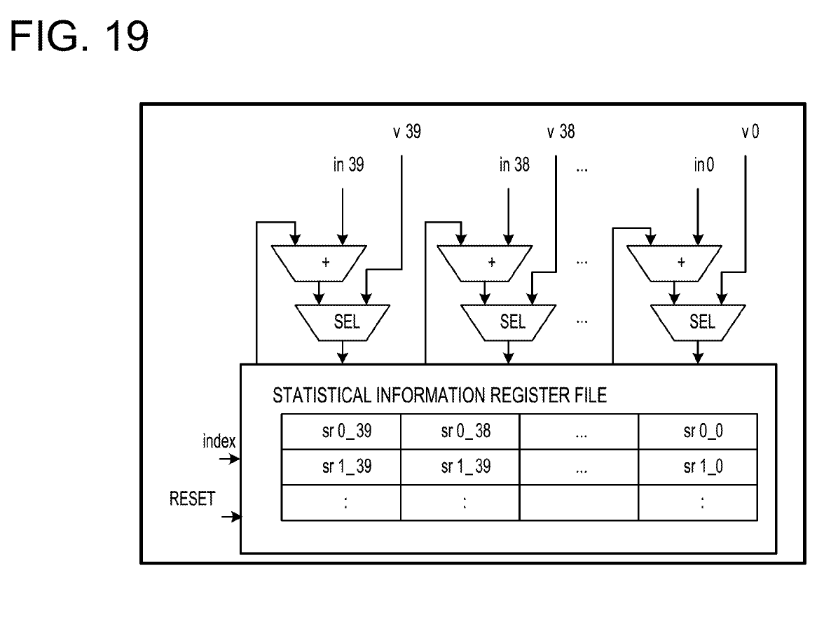

FIG. 19 is a specific configuration example of the statistical information aggregating circuit 104, and is a configuration example of a circuit in which a storage destination of statistical information is specified by an index from the decoder 112. In the drawing, for example, a region of sr[j][i] (j=0, . . . , k, i=0, . . . , 39) is secured, and a row j of a register file is specified by an index.

The processor 10 writes initial values to one or more registers in the row j of the register file specified by the index, via the selector SEL by a write command. Meanwhile, the processor 10 may reset the row j of the register file specified by the index, by a control signal from the decoder 112. Then, the processor 10 accumulates statistical information of in39 to in0 by using an adder, and stores the statistical information in the row j of the register file specified by the index. The processor 10 reads the statistical information from the row j of the register file specified by the index, by a control signal from the decoder 112. The processor 10 reads any one or more values from the row j of the register file specified by the index, and saves the read value in a data memory specified by a read command, or stores the read value in a general-purpose register specified by a read command.

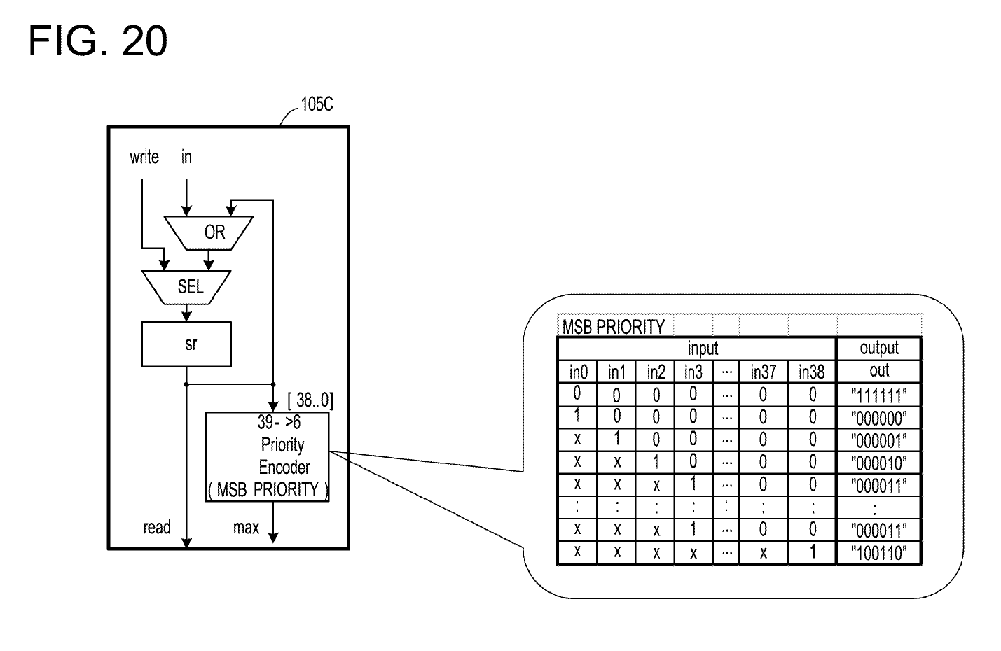

FIG. 20 is a view exemplifying a configuration of a hardware circuit of a statistical information storage circuit 105C that accumulates statistical information of bit positions ORed by the statistical information aggregating circuit 104B exemplified in FIGS. 17 and 18 and reads the maximum value of the bit positions in the accumulated statistical information. The statistical information storage circuit 105C includes a register (sr) that accumulates the statistical information of the bit positions ORed by the statistical information aggregating circuit 104B. The processor 10 is capable of writing an initial value to the register (sr) via the selector SEL by a write command (write). Meanwhile, the processor 10 may reset the register (sr) by a reset signal.

The statistical information storage circuit 105C executes an OR operation of an OR operation result (in) of the statistical information aggregating circuit 104B, and statistical information already accumulated in the register (sr), and accumulates the result of the OR operation in the register (sr) via the selector SEL.

The processor 10 reads a value of the register (sr) by a read command, and saves the read value in a data memory specified by the read command or a general-purpose register specified by the read command. The statistical information storage circuit 105C may include a priority encoder (MSB priority). The priority encoder (MSB priority) outputs the position (−1 to 38) of the most significant bit 1 in a bit string accumulated in the register (sr), as a binary number. For example, when all the bits 0 are input as input data in, the priority encoder (MSB priority) outputs “111111” (−1). When data, in which in0=1, and all other bits are 0, is input as input data in, the priority encoder (MSB priority) outputs “000000”(0). When data, in which in0=x (0 or 1), in1=1, and all other bits are 0, is input as input data in, the priority encoder (MSB priority) outputs “000001” (1). Likewise, when data, in which in0 to in37 are x (0 or 1), and in38=1, is input as input data in, the priority encoder (MSB priority) outputs “100110″”#$%38). The processor 10 may acquire the maximum value of the bit positions as a binary value through the priority encoder (MSB priority), from the statistical information of the bit positions ORed by the statistical information aggregating circuit 104B. A combination of the statistical information aggregating circuit 104B (FIGS. 17 and 18) that aggregates bit positions by an OR operation as in FIGS. 17 and 18, and the statistical information storage circuit 105C is an example of a circuit that accumulates a bit string which indicates the position of the most significant bit not matching a sign bit with a true value by an OR operation with respect to a plurality of fixed point number data pieces, and acquires the position of the most significant true value in the accumulated bit string.

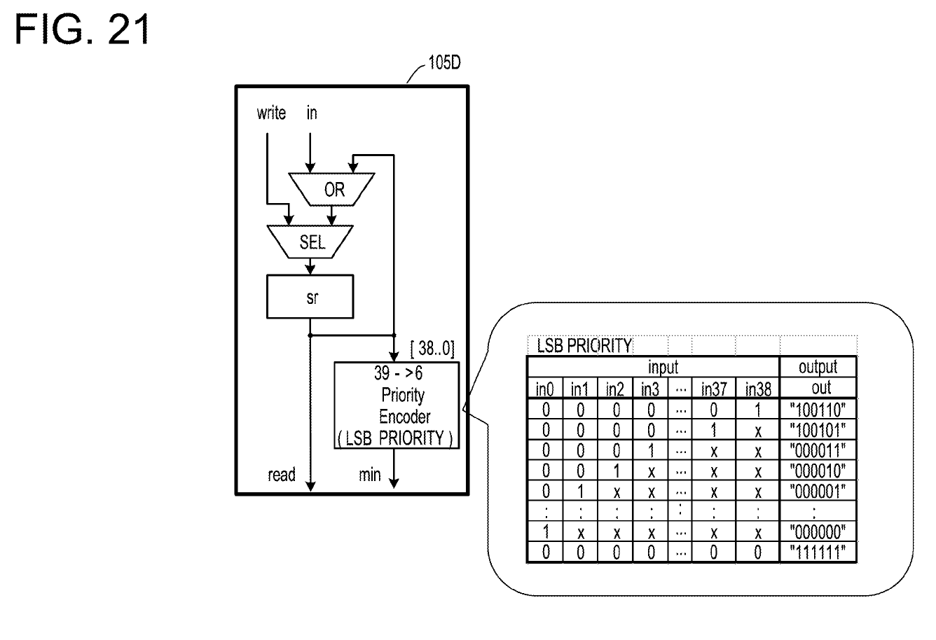

FIG. 21 is a view exemplifying a configuration of a hardware circuit of a statistical information storage circuit 105D that accumulates statistical information of bit positions ORed by the statistical information aggregating circuit 104B exemplified in FIGS. 17 and 18 and reads the minimum value of the bit positions in the accumulated statistical information. The statistical information storage circuit 105D includes a priority encoder (LSB priority) instead of the priority encoder (MSB priority) of the statistical information storage circuit 105C. The configuration of the statistical information storage circuit 105D except for the priority encoder (LSB priority) is the same as that of the statistical information storage circuit 105C, and thus explanations thereof will be omitted.

The priority encoder (LSB priority) outputs the position (−1 to 38) of the least significant bit 1 in a bit string accumulated in the register (sr), as a binary number. For example, when all the bits 0 are input as input data in, the priority encoder (LSB priority) outputs “111111” (−1). When data, in which in0=1, and other bits are x (0 or 1), is input as input data in, the priority encoder (LSB priority) outputs “000000” (0). When data, in which in0=0, in1=1, and other bits (in2 to in38) are x (0 or 1), is input as input data in, the priority encoder (LSB priority) outputs “000001” (1). Likewise, when data, in which in0 to in37 are 0, and in38=1, is input as input data in, the priority encoder (LSB priority) outputs “100110” (38). The processor 10 may acquire the minimum value of the bit positions as a binary value through the priority encoder (LSB priority), from the statistical information of the bit positions ORed by the statistical information aggregating circuit 104B. A combination of the statistical information aggregating circuit 104B (FIGS. 17 and 18) that aggregates bit positions by an OR operation, and the statistical information storage circuit 105D (FIG. 21) is an example of a circuit that accumulates a bit string which indicates the position of the least significant bit not matching a sign bit, with a true value, by an OR operation with respect to a plurality of fixed point number data pieces, and acquires the position of the least significant true value in the accumulated bit string.

### Effect of First Embodiment

The information processing apparatus 1 accumulates statistical information of each variable of each layer, in a register or a register file, at the time of mini batch execution of deep learning. Then, the information processing apparatus 1 may update a decimal point position of each variable of each layer based on the accumulated statistical information. That is, the processor 10 acquires statistical information of a bit distribution. Here, the statistical information includes, at the time of command execution, for example, (1) a distribution of positions of most significant bit at which value is not the same to the sign bit, (2) a distribution of positions of least significant bit at which value is not the same to the sign bit, (3) a maximum value of positions of most significant bit at which value is not the same to the sign bit, (4) a minimum value of positions of least significant bit at which value is not the same to the sign bit, or a combination thereof. Accordingly, when the information processing apparatus 1 executes deep learning, it is possible to implement a dynamic fixed point operation in a practical time without overhead during the deep learning program for acquiring statistical information of data.

That is, in the present embodiment, the processor 10 of the information processing apparatus 1 executes an instruction with a statistical information acquisition function, and executes an instruction to perform bit-shifting and rounding/saturation on an operation result and to store the result in a register. Accordingly, the information processing apparatus 1 may reduce overhead for acquiring statistical information indicating a bit distribution. It is possible to immediately determine a proper bit shift, that is, a decimal point position from the statistical information indicating a bit distribution. That, as in the information processing apparatus 1, without a procedure of determining a proper decimal point position by shifting a decimal point position bit by bit, and confirming the result in the next operation, it is possible to immediately determine the decimal point position from the statistical information indicating a bit distribution. Therefore, the information processing apparatus 1 is less likely to repeat a learning processing in a state where a decimal point position is improper. In the information processing apparatus 1, there is little possibility that learning accuracy is deteriorated and thus convergence of deep learning is delayed.

The processor 10 may acquire a position of the most significant bit not matching a sign bit in fixed point number data after execution of an instruction, by the statistical information acquisition circuit 102A. The processor 10 may accumulate and count the position of the most significant bit not matching a sign bit with respect to a plurality of fixed point number data pieces, by the statistical information aggregating circuit 104A. The processor 10 accumulates a bit string indicating the position of the most significant bit not matching a sign bit, with a true value, by an OR operation with respect to a plurality of fixed point number data pieces. Then, the processor 10 may acquire the position of the most significant true value in the accumulated bit string.

The processor 10 may acquire a position of the least significant bit not matching a sign bit in fixed point number data after execution of an instruction, by the statistical information acquisition circuit 102B. The processor 10 may accumulate and count the position of the least significant bit not matching a sign bit with respect to a plurality of fixed point number data pieces, by the statistical information aggregating circuit 104A. The processor 10 accumulates a bit string indicating the position of the least significant bit not matching a sign bit, with a true value, by an OR operation with respect to a plurality of fixed point number data pieces. Then, the processor 10 may acquire the position of the least significant true value in the accumulated bit string. Through the above described configuration, the processor 10 may acquire the statistical information.

### Second Embodiment

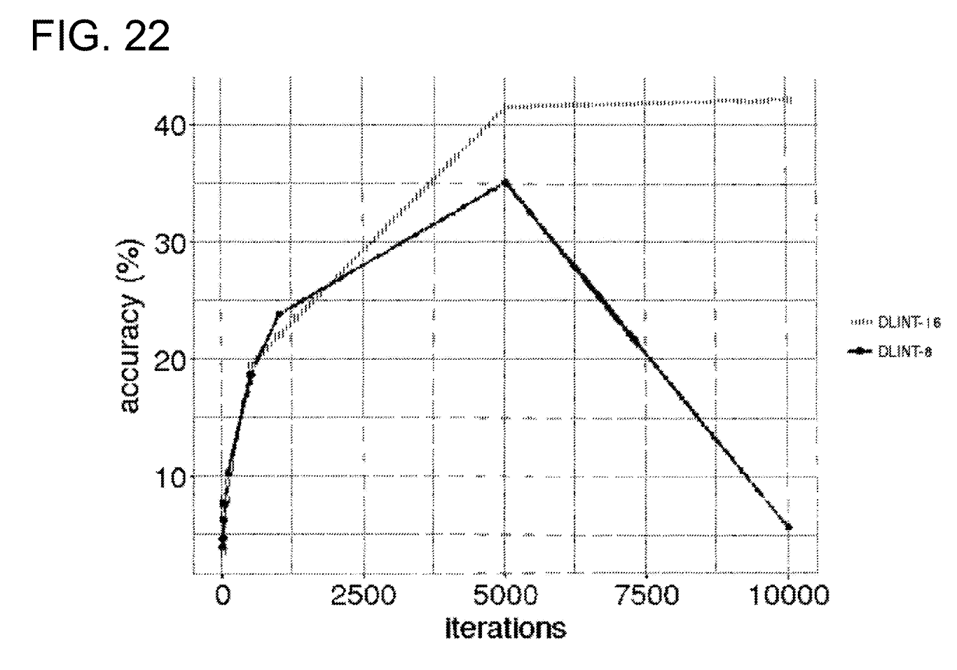

Hereinafter, with reference to FIGS. 22 to 46, descriptions will be made on an information processing system according to a second embodiment and a host machine 3. In the above first embodiment, descriptions have been made on the processor 10 that acquires statistical information by the statistical information acquisition circuit 102 (102A, 102B), and adjusts a decimal point position of fixed point number data such that, for example, the number of times of overflow is within a predetermined limit so as to efficiently execute deep learning with fixed point number expression. It can be said that the statistical information includes a distribution of values of operation results.

### Problem in First Embodiment

In the configuration of the first embodiment, the following problems are assumed. In the configuration of the processor 10 in the first embodiment, since each arithmetic circuit acquires statistical information, a circuit scale increases as the number of arithmetic circuits increases. On the contrary, when the arithmetic circuits each having a statistical information acquisition function are limited in the processor 10, an increase of a circuit scale is suppressed. However, when the arithmetic circuits each having a statistical information acquisition function are limited, since the number of statistical information samples is insufficient, a case is assumed in which an application program executed in the processor 10 estimates an improper decimal point position. When the improper decimal point position is estimated, the operation result becomes undesirable. For example, a case may occur in which a case where a recognition accuracy, a correct answer rate, etc. of deep learning does not fall within the assumed range increases. In particular, it is expected that a case where calculation may not be performed as expected when an operation bit width is small, such as 8-bit fixed decimal point expression, increases. Therefore, a method of keeping the calculation as expected while suppressing an increase of a circuit scale is desired.

FIG. 22 is an example of a result when learning is performed 10,000 times in a network called VGG8 that is obtained by simplifying an image classification learning network called VGG16. In this example, in the method using an operation by 16-bit dynamic fixed point numbers, the recognition accuracy becomes about 40% in10,000 learnings (see DLINT-16 in the drawing). Meanwhile, in the method using an operation by 8-bit dynamic fixed point numbers, the recognition accuracy drops to 5% in10000 learnings (see DLINT-8 in the drawing).

In deep learning, the number of times a variable value is generated (the number of times of operation by an arithmetic circuit) varies according to a variable (the type of a value). When the number of times the variable value is generated is small, an opportunity that statistical information on a decimal point position is acquired is reduced. A case is assumed in which it is not possible to accurately estimate the decimal point position. For example, in a calculation of parameter values to be input to nodes (also called neurons) of each layer in a multilayered neural network and a calculation of a weight in each neuron, the number of times of calculation is large. Thus, the opportunities that statistical information on an integer part digit of a fixed point number is acquired, that is the number of samples, is large. Meanwhile, in a calculation of a constant in each neuron and in a probability calculation for classification by, for example, an activation function, the number of times of calculation is small. Thus, the number of samples of statistical information on an integer part digit of a fixed point number is small.

Therefore, in the second embodiment, the following improvements are added to an application program (hereinafter, simply referred to as a program) using statistical information. That is, in the second embodiment, the program using the statistical information reduces the bit width for variables with many opportunities that statistical information is acquired, and secures a wide bit width for variables with small opportunities that statistical information is acquired. For example, the program uses a floating point number expression for variables with small opportunities that statistical information is acquired. The excess/insufficiency of opportunities that statistical information is acquired may be considered as the excess/insufficiency of the number of times statistical information is acquired, and thus as the excess/insufficiency of the number of samples of statistical information. That is, the information processing system according to the second embodiment and the host machine 3 determine a data type of a variable according to the excess/insufficiency of the number of times statistical information is acquired, and generate a program in which the variable according to the determined data type is incorporated.

In deep learning of the second embodiment, it is assumed that information prescribing a configuration of a neural network is defined in advance. The present information processing system and the host machine 3 generate a program to be executed based on the previously defined information prescribing a configuration of a neural network (hereinafter, neural network description information). For example, as the neural network description information, a prototext file in a software library (also called a framework) called caffe, a graph expression in a software library called tensorflow, and a python script in a software library called chainer are known. The neural network description information is an example of definition information defining a neural network.

It is possible to acquire the number of times a variable value is generated, from the neural network description information. It is possible to obtain the number of times statistical information is acquired, from thinning information in a statistical information acquisition function. The thinning information indicates N in a case where statistical information is acquired once per N variable value generations in the statistical information acquisition function. The thinning information may be determined from a hardware configuration. Therefore, it is possible to calculate the number of times the statistical information is acquired, from the number of times the variable value is generated and the thinning information. The information processing system according to the second embodiment and the host machine 3 generate a deep learning program executable in a processor having functions of a dynamic fixed point number operation and a fixed point number operation. When the program is generated, the present information processing system and the host machine 3 determine the type of data such that a bit width of a fixed decimal point is increased or a floating point number is used, for variables determined to have a small number of times statistical information is acquired (e.g., 30 times or less), with reference to a network structure of deep learning defined in the neural network description information. Meanwhile, the present information processing system and the host machine 3 determine the type of data such that a bit width of a fixed decimal point is reduced, for variables determined to have a large number of times statistical information is acquired.

As described above, the information processing system according to the second embodiment and the host machine 3 are different from the information processing apparatus 1 according to the first embodiment in that the number of times statistical information is acquired is analyzed for each variable based on the neural network description information, and the data type of a variable is determined according to the excess/insufficiency of the number of times the statistical information is acquired. Therefore, the information processing system according to the second embodiment and the host machine 3 are different from that of the first embodiment, in the processing of the program to be executed, whereas other constituent elements and actions are the same as those in the first embodiment. Thus, among constituent elements in the second embodiment, constituent elements to which the configuration of the information processing apparatus 1 according to the first embodiment is applied are given the same reference numerals as those of the first embodiment and referenced, and explanations thereof will be omitted.

<Configuration>

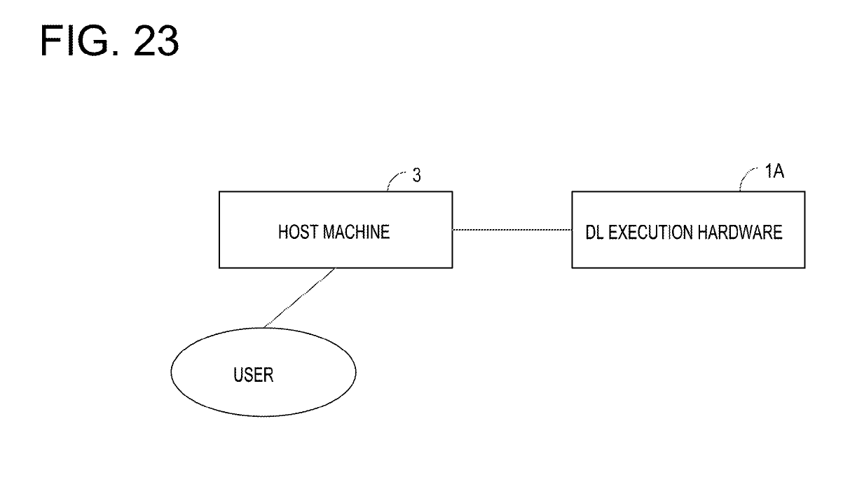

FIG. 23 exemplifies a configuration of the information processing system according to the second embodiment. In the second embodiment, the information processing system will be described with reference to an example in which the host machine 3 is connected to a DL execution hardware 1A on a dedicated interface. A user connects to the host machine 3 and the host machine 3 controls the DL execution hardware 1A so that deep learning (hereinafter, simply referred to as DL (Deep Learning)) is executed. According to an instruction from the user, the host machine 3 generates a program to be executed by the DL execution hardware 1A, and transmits the program to the DL execution hardware 1A. The DL execution hardware 1A executes the transmitted program and then generates result data. The host machine 3 in FIG. 23 is an example of a processor different from the DL execution hardware 1A (and a DL execution processor 10A) as an example of an arithmetic processing circuit. In the second embodiment, the host machine 3 executes a processing as a generation circuit that generates a program.

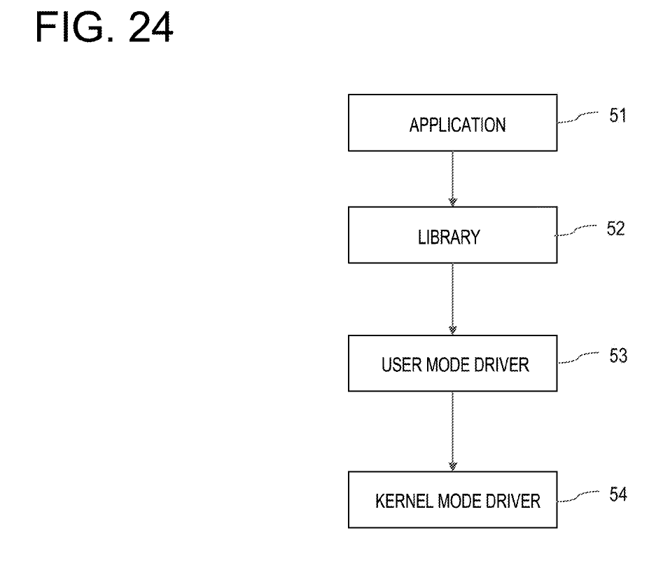

FIG. 24 is a view exemplifying a configuration of modules when the host machine 3 executes deep learning by using the DL execution hardware 1A. As in the drawing, the host machine 3 includes an application 51, a library 52, a user mode driver 53, and a kernel mode driver 54. The application 51 implements a user interface with a user. The application 51 receives design information of DL from the user and displays the result.

The host machine 3 implements a DL execution function by using a function of the library 52. The library 52 assists or supports implementation of the application 51 in the host machine 3. That is, a function related to execution of DL is provided by the library 52.

The user mode driver 53 is generally called from the library 52. Meanwhile, in some cases, the user mode driver 53 is directly called from the application 51.

The user mode driver 53 generates a program code for the DL execution hardware 1A. The user mode driver 53 is a driver executed in a user mode of an operating system (OS).

The kernel mode driver 54 is called from the user mode driver, and communicates with the DL execution hardware 1A. That is, a processing of communication with the DL execution hardware 1A is a direct access to hardware, and thus implementation as the kernel mode driver 54 is made. The kernel mode driver 54 is a driver executed in a kernel mode of an OS.

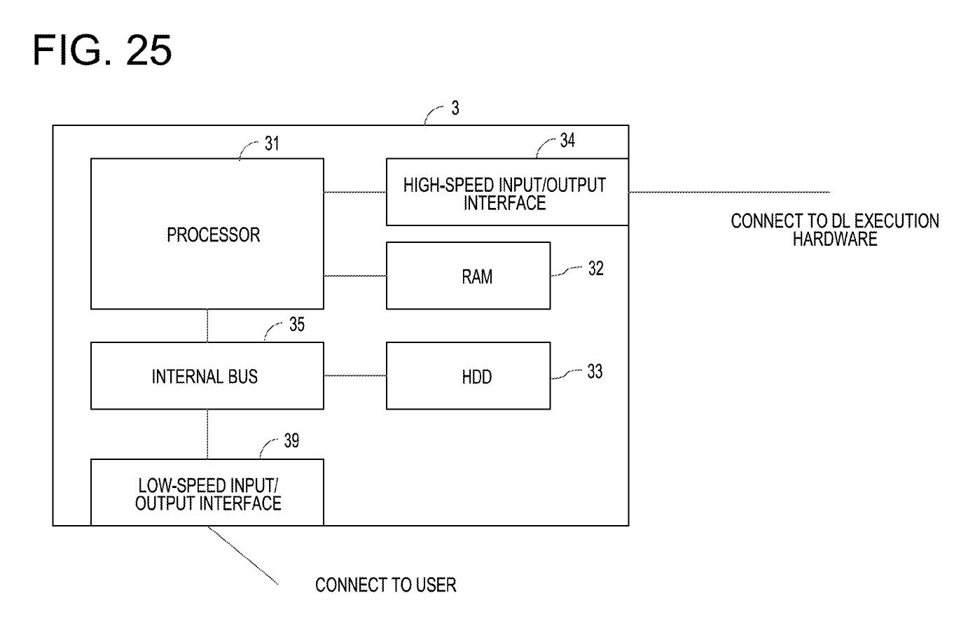

FIG. 25 exemplifies a configuration of the host machine 3. The host machine 3 includes, for example, a processor 31, a high-speed input/output interface 34, a random access memory (RAM) 32, an internal bus 35, a hard disk drive (HDD) 33 as an external storage device, and a low-speed input/output interface 39. The host machine 3 is an example of an information processing apparatus that generates a program.

The processor 31 executes a program arranged on the RAM 32. The high-speed input/output interface 34 connects the processor 31 to the DL execution hardware 1A present outside the processor 31. As an example of the high-speed input/output interface 34, peripheral component interconnect (PCI) express etc. may be exemplified. In the RAM 32, the program executed by the processor 31 or data is arranged. As the format of the RAM 32, DDR4-SDRAM is exemplified. The internal bus 35 connects a peripheral device having a lower speed than the processor 31 to the processor 31, thereby relaying a communication. The HDD 33 operates as a non-volatile auxiliary storage device, and permanently stores the program executed by the processor 31 or data. The low-speed input/output interface 39 performs a communication with a user. As an example of the low-speed input/output interface 39, a connection portion with a keyboard or a mouse via a universal serial bus (USB) is exemplified. As the low-speed input/output interface 39, a communication circuit that executes a communication via a network such as Ethernet may also be exemplified.

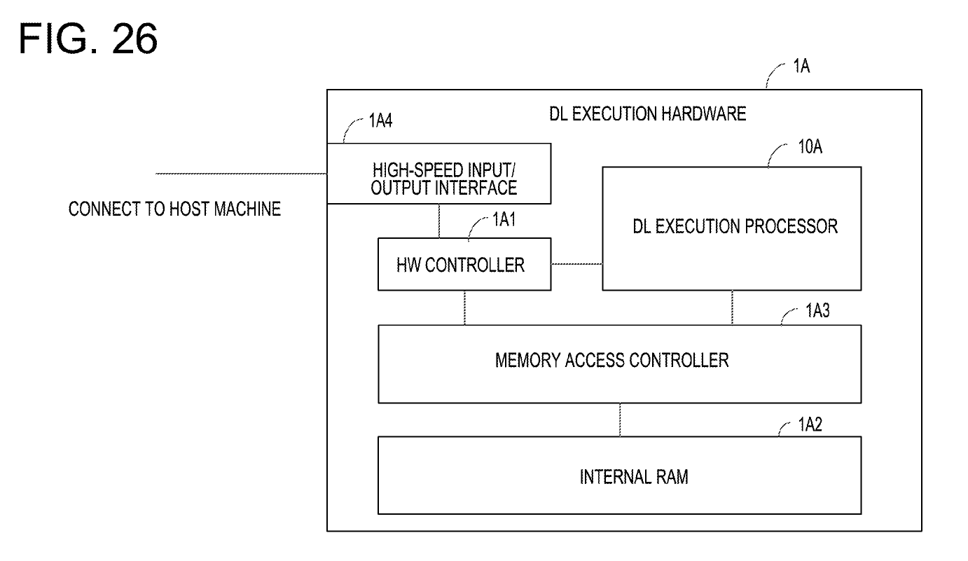

FIG. 26 exemplifies a configuration of the DL execution hardware 1A. The DL execution hardware 1A includes the DL execution processor 10A, a hardware (HW) control circuit 1A1, a high-speed input/output interface 1A4, a memory access controller 1A3, and an internal RAM 1A2.

The DL execution processor 10A executes a processing of deep learning based on a program and data provided from the host machine 3. An example of the DL execution processor 10A is, for example, the processor 10 in the first embodiment. The DL execution processor 10A is an example of an arithmetic processing circuit. The HW control circuit 1A1 drives the DL execution processor 10A based on a command from the host machine 3. The HW control circuit 1A1 receives a command from the host machine 3, and transmits a program or data to the internal RAM 1A2. The high-speed input/output interface 1A4 is connected to the host machine 3. As a specific protocol of the high-speed input/output interface 1A4, the above described PCI Express is exemplified. The memory access controller 1A3 selects a signal from the DL execution processor 10A or the HW control circuit 1A1, and accesses the internal RAM 1A2 according to a protocol for a memory access. The internal RAM 1A2 stores a program executed by the DL execution processor 10A, data to be processed, or data as a processing result. As the internal RAM 1A2, a double-data-rate (DDR) 4-synchronous dynamic random access memory (SDRAM), a faster graphics double data rate (GDDR) 5, or a high bandwidth memory (HBM) 2 with a higher bandwidth may be exemplified.

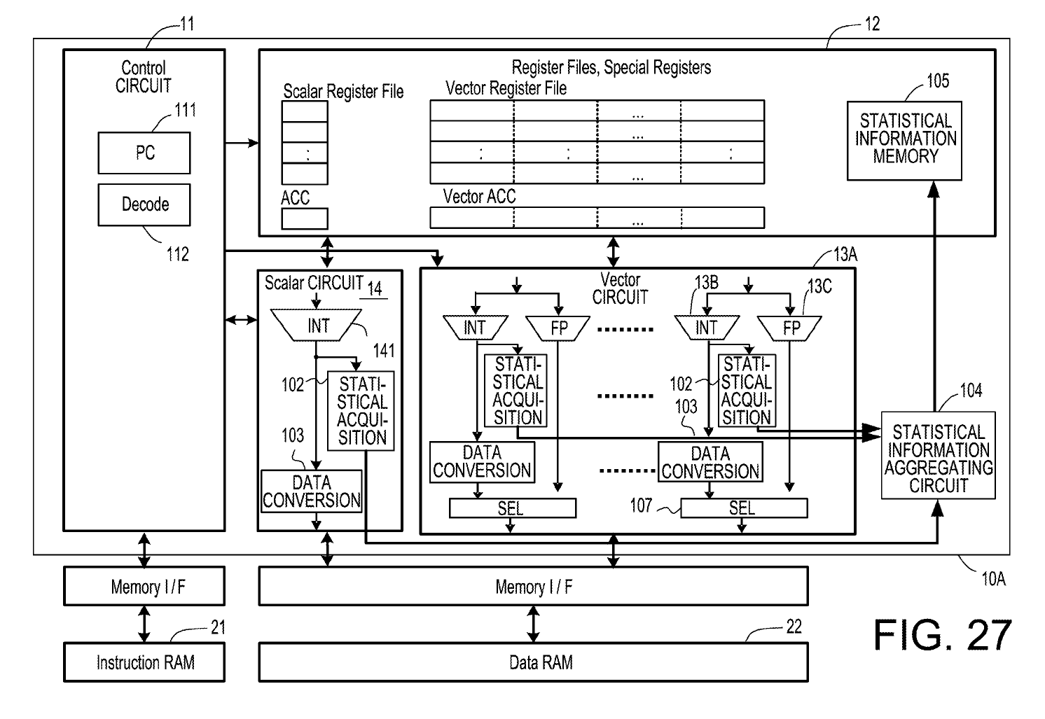

FIG. 27 exemplifies a configuration of the DL execution processor 10A in the second embodiment. In FIG. 27, an instruction memory 21 and a data memory 22 connected to the DL execution processor 10A via the memory interface are also described. Among them, the configuration of the instruction memory 21 and the data memory 22 is the same as that of the processor 10 in the first embodiment, and thus explanations thereof will be omitted.

The DL execution processor 10A includes a control unit 11, a register file 12, a vector unit 13A, and a scalar unit 14. Among them, the control unit 11 is the same as that in the first embodiment, and thus explanations thereof will be omitted.

The vector unit 13A has a plurality of sets each including a vector operation fixed point number arithmetic circuit 13B (indicated by INT in the drawing), a vector operation floating point number arithmetic circuit 13C (indicated by FP in the drawing), a statistical information acquisition circuit 102 (omitted as “statistical acquisition” in the drawing), a data converting circuit 103 (omitted as “data conversion” in the drawing) and a selector 107. Therefore, the DL execution processor 10A executes at least one of an operation of a fixed point number and an operation of a floating point number by the vector unit 13A. The plurality of sets are, for example, eight sets, but the number of sets of arithmetic circuits within the vector unit 13A is not limited to eight. In the drawing, as an example, the fixed point number arithmetic circuit 13B, the floating point number arithmetic circuit 13C, the data converting circuit 103, and the selector 107 in one set are denoted by reference numerals. The vector unit 13A executes operations in parallel by a plurality of sets of arithmetic circuits. Among them, the configuration of the data converting circuit 103 is the same as that in the first embodiment, and thus explanations thereof will be omitted.

For example, the vector operation fixed point number arithmetic circuits 13B are prepared as a plurality of sets as described above, and execute fixed point number operations in parallel, for example, additions. The vector operation floating point number arithmetic circuits 13C are also prepared as a plurality of sets as described above, and execute floating point number operations in parallel, for example, additions. As described above, the vector unit 13A is the same as the vector unit 13 in the first embodiment, except that the vector operation floating point number arithmetic circuit 13C is added. Hereinafter, the configuration of FIG. 27 will be described in more detail, and an operation of the DL execution processor 10A will be described.

(Register)

In FIG. 27, a scalar register file has, for example, 32 32-bit registers. The scalar register file stores addresses or parameters. In FIG. 27, “ACC” is a scalar accumulator register.

A vector register file has, for example, eight sets of 32-bit vector registers. Each of the eight sets of 32-bit vector registers has eight register elements accessible in parallel. Meanwhile, the vector register file may be used as, for example, a configuration having eight sets each including 16 16-bit vector register elements. The vector register file may be used as, for example, a configuration having eight sets each including 32 8-bit vector register elements.

The vector register file is expressed as simd0 to simd as an assembly language operand, and stores operation data. Hereinafter, when a register is constituted by N bits, the number of elements accessible in parallel is M, and the number of sets is S, a register file will be expressed by N bits×M elements×S sets.

(Vector Acc)

In FIG. 27, “Vector Acc” refers to an accumulator register for a vector operation. The Vector Acc may be used in80 bits×8 elements×1 set (32 bit operation mode), 40 bits×16 elements×1 set (16-bit operation mode), or 20 bits×32 elements×1 set (8-bit operation mode). The Vector Acc is expressed as, for example, acc as an assembly language operand, and stores a multiplication result between vector registers or an addition result thereof.

(Type of Scalar Operation)

As a scalar operation executable by the processor 10A, four fundamental arithmetic operations (integer, floating decimal point), shift, branch, load, and store are exemplified.

(Vector Operation (SIMD Operation))

A vector operation executable by the processor 10A is as follows. First, as a single-precision floating point operation, operations such as addition/subtraction and multiplication, loading, storing, and conversion to a fixed decimal point expression (acquisition of an exponent part and a mantissa part) are exemplified. As an operation using the Vector Acc (a single-precision floating decimal point expression), clearing of an accumulator register, and a MAC (Multiply and ACcumulate) operation are exemplified. In the MAC operation, the Vector Acc is implicitly specified for addition and output operands. As an integer operation, addition/subtraction, multiplication, a shift operation, and generation in a floating decimal point expression (setting of an exponent part and a mantissa part) are exemplified.

A processing of the MAC (Multiply and ACcumulate) operation is as follows. The operation is a processing of integrating a product of two variables (register values) to acc, and is exemplified by the following expression.

acc=16 bit×16 bit+acc (16-bit mode) or

acc=8 bit×8 bit+acc (8-bit mode)

In the operation, two Vector Registers are specified. For addition and output operands, a Vector Acc is implicitly specified.

A processing of accumulated addition is as follows. The operation is a processing of integrating one variable (register value) to acc, and is exemplified by the following expression.

acc=16 bit+acc (16-bit mode) or

acc=16 bit+acc (8-bit mode) or

acc=8 bit+acc (8-bit mode)

In the operation, one Vector Register and one Scalar Register are specified. Meanwhile, in the case of 16 bits+acc (8-bit mode), two Vector Registers are read. The DL execution processor 10A has 16-bit Vector Registers as 16 elements, and acc may use 32 elements in an 8-bit mode. Thus, it is possible to process two 16-bit Vector Registers. In the Scalar Register, a shift amount of an input operand is specified.

In an instruction of transmission to the Vector Register, one Vector Register, and one Scalar Register are specified. In the Scalar Register, a shift amount of a Vector Acc is specified.

(Load Instruction)

In a load instruction, a read address, stride, type conversion, and a writing destination Vector Register are specified for an operand. Stride=0 means that one element of a read address is stored in all Vector Register elements. When stride=1, one element at a time is read from a read address and then is stored in each element of a Vector Register. When stride=N (an arbitrary integer), elements specified by addresses of read address+element width×N×element number are sequentially read and stored in each element of a Vector Register. For an instruction of type conversion, the type of a read source (a 8-bit integer or a 16-bit integer) and the type of storage in a register (a 8-bit integer or a 16-bit integer) are specified.

(Store Instruction)

A write address, stride, and a read source Vector Register are specified. Regarding the stride, the same as the load is applied.

(Processing of Statistical Information Acquisition Circuit)

The configuration of the statistical information acquisition circuit 102 is the same as that of the statistical information acquisition circuit 102 (102A, 102B) in the first embodiment. That is, the statistical information acquisition circuit 102 analyzes each element stored in an accumulator register, acquires a position of a position of most significant bit at which value is not the same to the sign bit, and accumulates the distribution in the statistical information aggregating circuit 104. In the second embodiment, with a LSB position set as 0, a bit position is defined.

Statistical information may be stored in a plurality of systems, and the system is specified by an immediate value in an operand of an instruction. For example, when an operation result has a value of 0x00_1000_0000, the most significant bit position, at which a value 1 different from a sign bit appears with respect to the sign bit of 0, becomes 28. For example, when an operation result has a value of 0xFE_FFFF_FFFF, the most significant bit position, at which a value 0 different from a sign bit appears with respect to the sign bit of 1, becomes 32. The plurality of systems mean a plurality of storage destinations of statistical information. Since there are the plurality of storage destinations, for example, operands may be specified such that first statistical information may be stored in a first storage destination, and second statistical information may be stored in a second storage destination.

<Program Generation Processing>

The host machine 3 in the second embodiment determines the type of a variable for a product-sum operation and a summation operation among processings appearing in the calculation of a neural network, and then performs a program generation. In order to perform the program generation, the host machine 3 prepares a template of each processing, and modifies the contents of the template according to the given parameters so as to generate a desired program (also called a code).

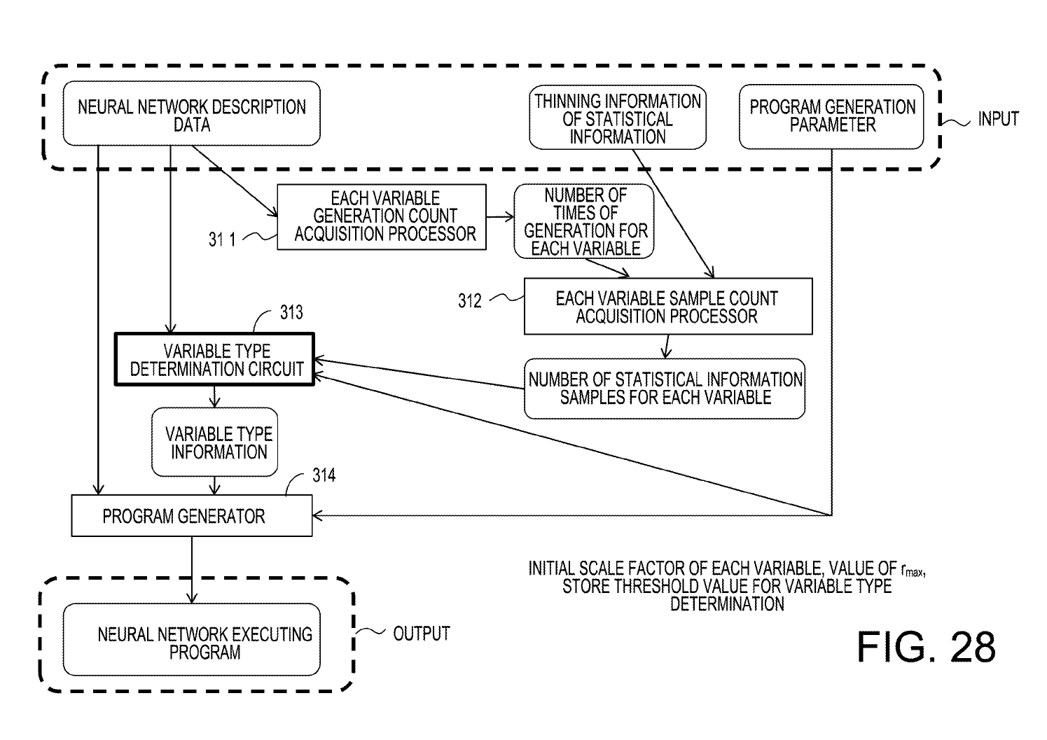

FIG. 28 exemplifies a logical configuration of the host machine 3 in relation to a program generation. The host machine 3 executes a processing in FIG. 28 by a computer program arranged in an executable manner in the RAM 32. As in the drawing, in the logical configuration, the host machine 3 includes an each variable generation count acquisition processing circuit 311, an each variable sample count acquisition processing circuit 312, a variable type determination circuit 313, and a program generation circuit 314. Here, at the time of program generation, the host machine 3 acquires neural network description information, thinning information of statistical information, and program generation parameters from an input. The input is, for example, a parameter specified for program activation, a parameter delivered from an OS, or a parameter described in a predetermined file of a file system.

Neural network description data includes, for example, the number of layers, the number of input values of each layer, the number of weights of each layer, and the number of constant addition values of each layer. The thinning information N of the statistical information is generally one integer, and indicates that a circuit of acquiring the statistical information at a ratio of once per N times is implemented. That is, the thinning information N of the statistical information means that the statistical information is acquired at a ratio of once with respect to N operations. The number of generations of each variable may be acquired from the neural network description data. For each variable, the number of times statistical information is acquired (the number of samples) may be obtained by the number of generations/thinning information (here, / indicates division). It can be said that the thinning information N is a ratio of acquisition of the statistical information with respect to the number of times of operation in the DL execution processor 10A as an example of an arithmetic processing circuit.

The program generation parameters include, for example, an initial value of a scale factor of each variable, or a threshold value of the number of times of acquisition (the number of samples) of each variable, which is used for determining the data type of a variable. The initial value of the scale factor is information that specifies a decimal point position of a fixed point number at the time of start of a processing.

The each variable generation count acquisition processing circuit 311 acquires the number of times a variable value is generated for each variable, for the neural network description data as the input, and delivers the acquired number of times to the each variable sample count acquisition processing circuit 312. It can be said that the number of times the variable value is generated for each variable is the number of times of operation in each layer of a neural network. The each variable generation count acquisition processing circuit 311 is an example of a first acquisition circuit.

The each variable sample count acquisition processing circuit 312 acquires the number of times statistical information is acquired (the number of samples) for each variable and delivers the acquired number of times to the variable type determination circuit 313, based on the number of times the variable value is generated for each variable, which is delivered from the each variable generation count acquisition processing circuit 311, and thinning information of statistical information input to a program. The each variable sample count acquisition processing circuit 312 is an example of a second acquisition circuit.

The variable type determination circuit 313 determines type information of a variable, based on the neural network description data and the number of times the statistical information is acquired (the number of samples) for each variable, which is delivered from the each variable sample count acquisition processing circuit 312. The program generation circuit 314 generates a program that executes a processing such as deep learning by modifying a template, and outputs the generated program to the DL execution processor 10A, based on the neural network description data, the program generation parameters, and the variable type information delivered from the variable type determination circuit 313. A combination of the variable type determination circuit 313 and the program generation circuit 314 is an example of a generation circuit that generates a program.

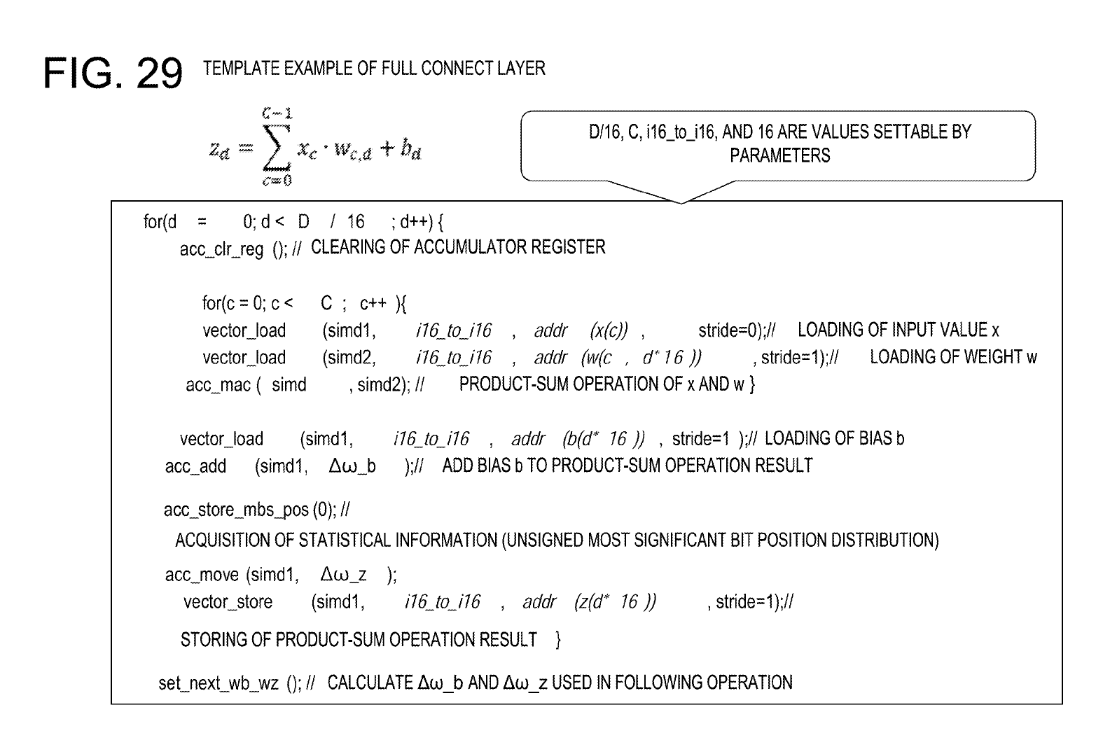

FIG. 29 exemplifies a template for generating a program of a full connect layer. A processing of this template example includes a loop of the number of data pieces D/16 times, and a loop in which a product-sum operation of C vectors is executed. This processing includes a processing of clearing an array of an accumulator register acc_cir_reg( ) in the loop of the number of data pieces D/16 times, and a processing of loading an input value x into a vector register, a processing of loading a weight w, and a processing of executing a product-sum operation of the input value x and the weight w in the loop of C times. This processing includes a processing of loading a bias b, a processing of adding the bias b to a product-sum operation result, a processing of acquiring statistical information (distribution of positions of most significant bit at which value is not the same to the sign bit), and a processing of storing the product-sum operation result in a memory, in the loop of D/16 times.

Among them, for example, the values D/16, C, and i16_to_i16 specifying the number of times of loop of the “for” loop are values that may be set by parameters. Therefore, the program generation circuit 314 may modify a template by modifying these parameters and may generate a program. Instead of i16_to_i16, parameters such as i16_to_i8, i8_to_i16, i16_to_f32, and f32_to_i16 may be used. The parameter i16_to_i16 specifies keeping of a 16-bit fixed point number (no change for a type), the parameter i16_to_i8 specifies changing from a 16-bit fixed point number into a 8-bit fixed point number, and the parameter i8_to_i16 specifies changing from a 8-bit fixed point number into a 16-bit fixed point number. The parameter i16_to_f32 specifies changing from a 16-bit fixed point number into a 32-bit floating point number, and the parameter f32_to_i16 specifies changing from a 32-bit fixed point number into a 16-bit floating point number. In the program in the drawing, numerical values such as 8 or 16 are parameters determined by an architecture of a processor. C is the number of input data pieces, and D is the number of output data pieces. The symbol D/16 indicates that 16 data pieces are output in parallel.

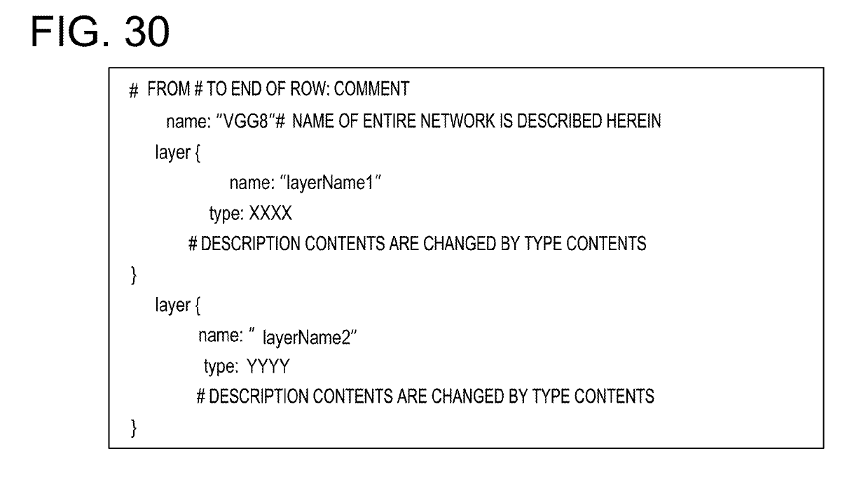

FIG. 30 exemplifies a configuration of neural network description data. Here, an example of description data in a format (prototext) used by a library called Caffe is illustrated. This description data defines each content of each layer, within layer{ }. For example, a layer name is defined for name, and a layer type is specified for type. Unique data is defined for each layer type. As many layers{ } as the number of layers are set.

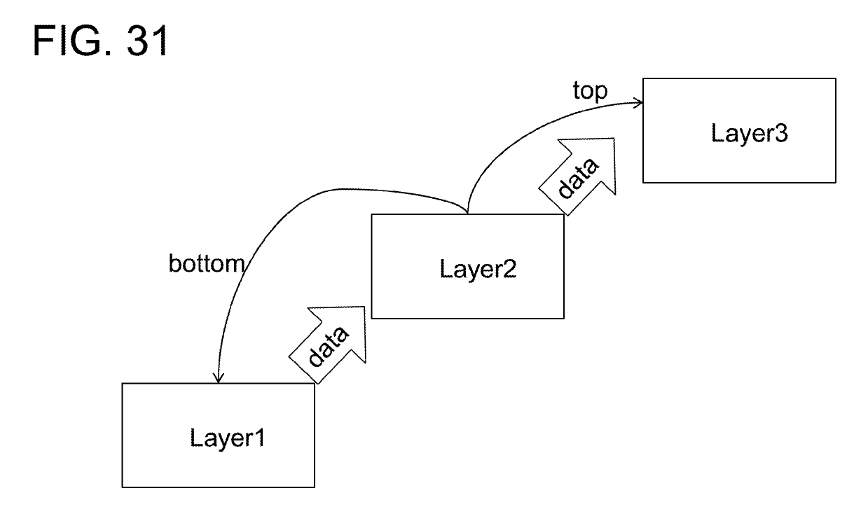

FIG. 31 exemplifies definitions of top and bottom in a prototext. There are top and bottom as prototext unique expressions. The top refers to a layer where output is made from a certain layer, and the bottom refers to a layer from which a certain layer obtains input. For example, when a processing is executed in the order of a Layer1, a Layer2, and a Layer3, a bottom of the Layer2 is the Layer1, and a top of the Layer2 is the Layer3.

FIG. 32 exemplifies definition of input data of a neural network, by a prototext. In the prototext, input data is also defined as one of layers. Here, the type is “Data.” As described above, an output destination of data is specified as top. The example of FIG. 32 indicates outputting to layers, conv1 and label. The conv1 indicates outputting to a convolution layer, and the label indicates outputting to correct answer determination at a final stage. More detailed information is described in data_param. In this example, a name of an input file (specified by source), a batch size (specified by batch_size), and a format (a format “LMBD” in backend) are stored.

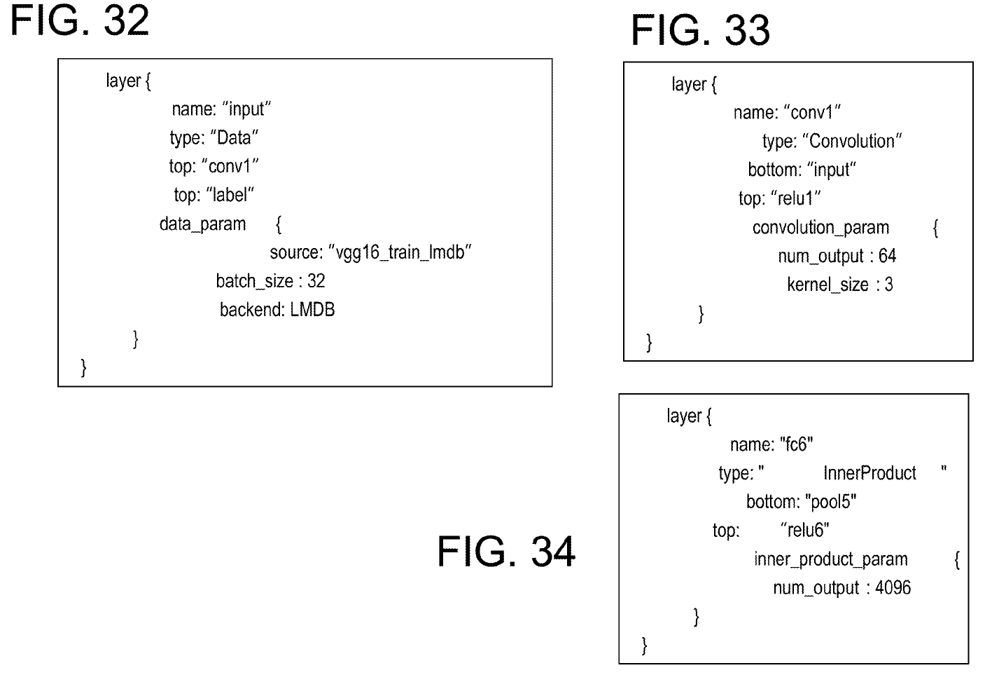

The program generation circuit 314 may read a file storing input information so as to obtain more detailed information other than the information exemplified in FIG. 32. For example, a size of an image file, and the number of input channels of the image file (the number of color channels) are acquired. These information pieces are used to calculate the number of sample acquisitions. FIG. 33 exemplifies definition of a convolution layer of a neural network, by a prototext.

In the convolution layer, a character string “Convolution” is specified as type. Since an input destination is the input data (name is “input”) of FIG. 32, a character string “input” is specified as top. convolution_param[ ] is a parameter of the convolution layer, and num_output specifies the number of output channels. In the case of FIG. 33, 64 channels are specified. kernel_size specifies a filter size of convolution. In the case of FIG. 33, a 3×3 filter is specified.

By obtaining an image size, the number of input channels, and the number of input images (batch size) from an input layer of a preceding stage, it is possible to obtain the number of times a variable value is generated, in the corresponding layer. For example, it is assumed that a size of an input image is 96×96, and a batch size is 32. That is, statistical information of images on 32 input images is collected. This layer outputs 64 channels with a filter size of 3×3. For simplicity, assuming that zero padding is used during convolution, a size of an input image is equal to a size of an output image. Therefore, in the convolution layer, the number of times the variable value is generated is as follows. The number of times=96×96×64×32=18874368

FIG. 34 exemplifies definition of a full connect layer of a neural network, by a prototext. In the full connect layer, a character string “InnerProduct” is specified as type. “inner_product_param[ ]” is a parameter of the full connect layer, and “num_output” specifies the number of output channels. In the case of FIG. 34, 4096 is specified. In the case of the full connect layer, since one data piece is generated per channel, 4096 data pieces are generated. Assuming that a batch size is 32, 131072 (=4096×32) data pieces are generated.

<Processing Flow of Program Generation>

(Simplified Flow of Program Generation)

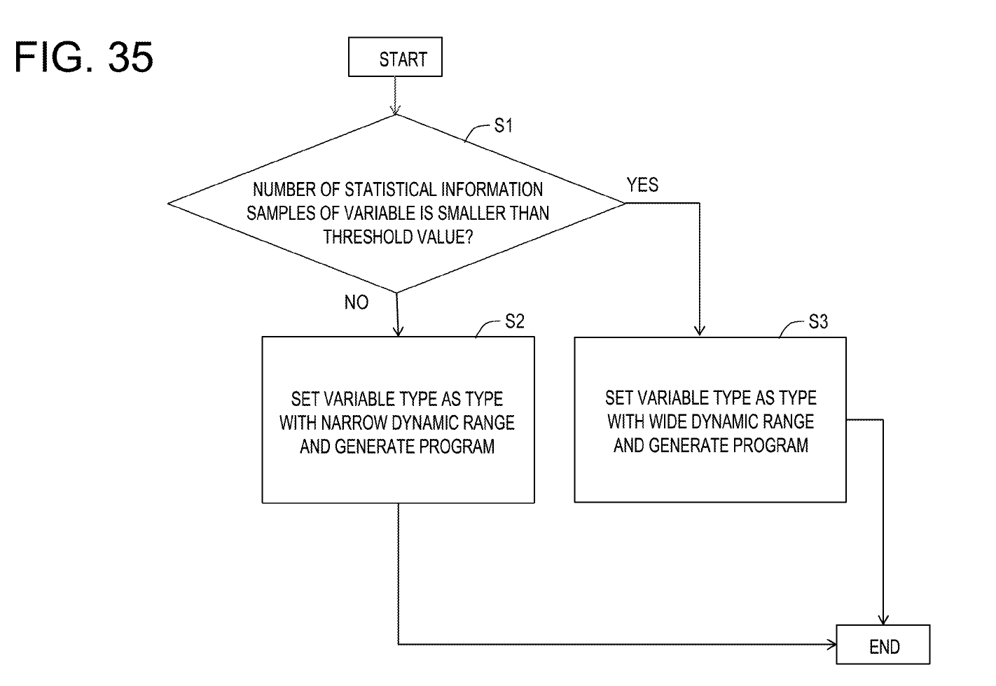

FIG. 35 exemplifies a simplified flow of a program generation in the second embodiment. FIG. 35 is a processing flowchart in which details are omitted in the description in order to briefly explain a processing in the second embodiment. In this processing, the variable type determination circuit 313 determines whether the number of statistical information samples of a variable is smaller than a threshold value. When the number of the statistical information samples of the variable has reached the threshold value (“NO” in S1), the variable type determination circuit 313 selects a type with a narrow dynamic range among selectable data types, and sets the selected type as a type of the variable. Then, the program generation circuit 314 generates a program according to the determined type (S2). Here, the dynamic range may be regarded as characteristic information indicating a range that a variable value may take, and may be defined by, for example, a ratio of a maximum value to a minimum value of expressible values. A case where the determination in S1 is NO is an example of a case where it is determined that the number of the statistical information samples is larger than the predetermined value. The processing in S2 is an example in which the generation circuit sets a data type with a smaller dynamic range as target data.

Meanwhile, when the number of the statistical information samples of the variable is smaller than the threshold value (“YES” in S1), the variable type determination circuit 313 selects a type with a wide dynamic range among selectable data types, and sets the selected type as a type of the variable. Then, the program generation circuit 314 generates a program according to the determined type (S3). A case where the determination in S1 is YES is an example of a case where it is determined that the number of the statistical information samples is smaller than the predetermined value. The processing in S3 is an example in which the generation circuit sets a data type with a larger dynamic range as target data.

(Threshold Value Determination Processing)

As described above, in the second embodiment, the variable type determination circuit 313 determines the type of a variable depending on whether the number of statistical information samples exceeds a threshold value. Here, the following methods may be considered as a method of determining the threshold value.

A first method is a method of mounting a threshold value as a parameter inside a generation program that generates a program for the DL execution processor 10A. That is, a method of hard-coding a threshold value itself inside a generation program may be exemplified. A second method is a method in which a threshold value is included in one of setting information pieces read from, for example, a file by a generation program that generates a program for the DL execution processor 10A.

As a third method, the host machine 3 may experimentally execute learning and determine a threshold value. For example, the host machine 3 experimentally executes learning N times that is smaller than the target number of times, in both a 32-bit floating decimal point expression and a fixed decimal point expression with a type determined by using a threshold value initial value. Then, when a learning error in the fixed decimal point expression is larger than a value obtained by adding a predetermined value be to a learning error in a case where the 32-bit floating decimal point expression is used, the host machine 3 executes a processing of increasing a threshold value related to each type determination, by a predetermined difference for each threshold value type. This processing increases the threshold value for type determination so that a type with a wider dynamic range may be easily selected. After changing the threshold value in this manner, the host machine 3 determines a type again, and re-executes experimental learning of a fixed decimal point. Then, when a condition that a learning error in the fixed decimal point is equal to or smaller than a value obtained by adding a predetermined value be to a learning error in a case where the 32-bit floating decimal point expression is used is satisfied, the host machine 3 ends the experimental learning, switches to an original processing, and continues to perform learning so as to formally set a threshold value.

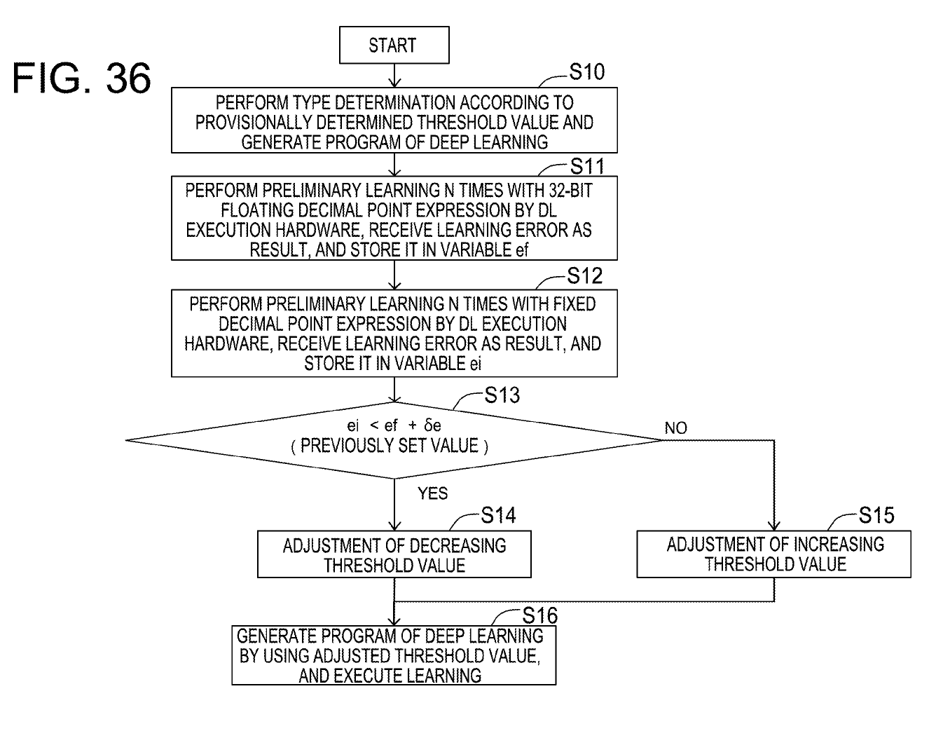

FIG. 36 exemplifies a threshold value determination processing.

Here, a processing is exemplified in which based on a provisionally determined threshold value, learning is experimentally executed N times that is smaller than the target number of times, and a threshold value is determined. In this processing, the variable type determination circuit 313 of the host machine 3 performs type determination according to a provisionally determined threshold value, and generates a program of deep learning (S10). Next, the host machine 3 causes the DL execution processor 10A to execute preliminary learning N times by using a 32-bit floating decimal point expression, receives a learning error as a result, and stores the learning error in a variable ef (S11). The value of the variable ef is an example of a learning error when deep learning is executed by using a floating point number. Then, the host machine 3 performs preliminary learning N times in a fixed decimal point expression by using the DL execution processor 10A, receives a learning error as a result, and stores the learning error in a variable ei (S12). The value of the variable ei is an example of a learning error when deep learning is executed by using a fixed point number. The processing in S11 and S12 is an example of executing deep learning a predetermined limited number of times.

Thereafter, the host machine 3 determines whether the error in the variable ei is smaller than the sum (referred to as a determination value) of the error in the variable ef and a previously set predetermined value (be) (S13). When the error in the variable ei is smaller than the determination value, the host machine 3 executes an adjustment of decreasing a threshold value (S14). Meanwhile, when the error in the variable ei is equal to or larger than the determination value, the host machine 3 executes an adjustment of increasing a threshold value (S15). Individually decreasing the threshold value makes it easier for the number of statistical information samples to be a value equal to or greater than the threshold value. As a result, this allows the variable type determination circuit 313 to easily select a variable with a narrow dynamic range. Meanwhile, increasing the threshold value makes it easier for the number of statistical information samples to be a value smaller than the threshold value. As a result, this allows the variable type determination circuit 313 to easily select a variable with a wide dynamic range. The processing in S13 to S15 is an example of determining a predetermined value based on a difference between a learning error when deep learning is executed by using a floating point number, and a learning error when deep learning is executed by using a fixed point number.

In FIG. 36, a threshold value is changed depending on whether the error in the variable ei is smaller than a single determination value in the determination of S13. Meanwhile, different determination values may be used for a case where the threshold value is increased and a case where the threshold value is decreased. For example, the sum of the error in the variable ef and the previously set predetermined value (be) may be set as a first determination value, and the sum of the error in the variable ef and a value corresponding to half the previously set predetermined value (be) may be set as a second determination value. Then, when the error in the variable ei is smaller than the first determination value, the host machine 3 may keep the threshold value, and when the error in the variable ei is smaller than the second determination value, the host machine 3 may execute an adjustment of decreasing the threshold value. The host machine 3 may repeatedly execute the processing in FIG. 36 until the error in the variable ei falls between the second determination value and the first determination value. It can be said that the processing in FIG. 36 is an example of a processing in a determination circuit that determines a predetermined value. It can be said that the host machine 3 executes the processing in FIG. 36, as an example of the determination circuit.

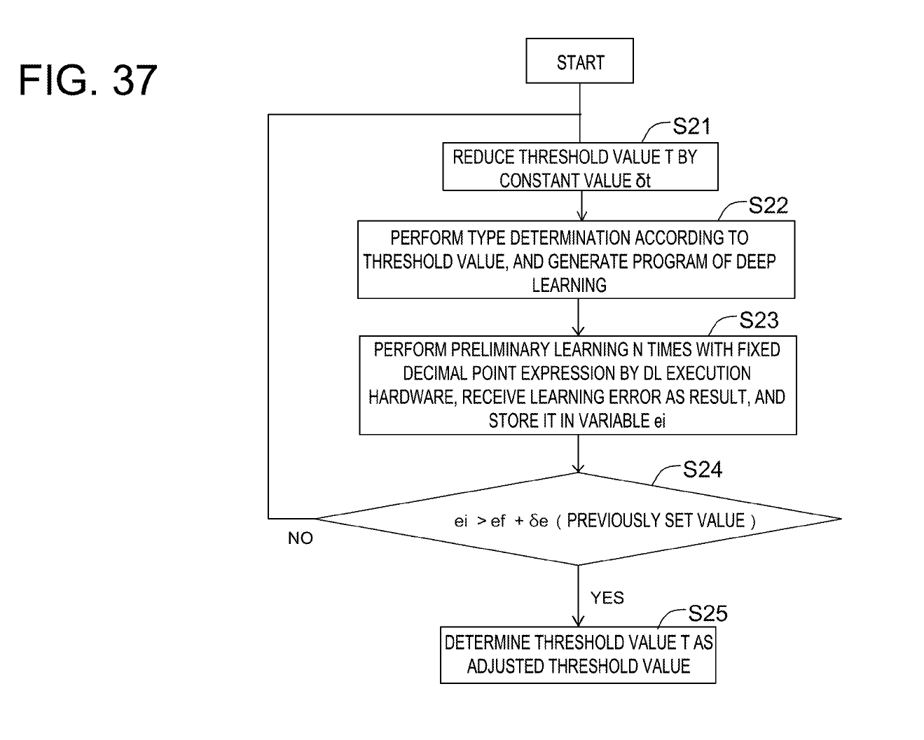

FIG. 37 exemplifies a first modification of the threshold value determination processing. In this processing, a provisionally determined threshold value T and a learning error of in a case of learning by a floating decimal point expression are given as inputs. In this processing, the provisionally determined threshold value T is set as a value larger than assumed. In this case, since it is determined that the number of statistical data samples is initially small, a dynamic range of a variable is set to be wide, and it is assumed that an error is small. The host machine 3 decreases a threshold value until the error increases to some extent.

The variable type determination circuit 313 of the host machine 3 reduces the threshold value T by a constant value a (S21). Then, the variable type determination circuit 313 of the host machine 3 performs type determination according to the threshold value, and generates a program of deep learning (S22). Thereafter, the host machine 3 executes preliminary learning N times in a fixed decimal point expression by using the DL execution processor 10A, receives a learning error as a result, and stores the learning error in a variable ei (S23). The processing in S22 is an example of executing deep learning a predetermined limited number of times.

Then, the host machine 3 determines whether the error of the variable ei is larger than the sum (a determination value) of the error of the variable ef and a previously set predetermined value be (S24). When the error of the variable ei is equal to or less than the determination value, the host machine 3 returns the processing to S21, and executes an adjustment of decreasing the threshold value. Meanwhile, when the error of the variable ei is larger than the determination value, the host machine 3 determines the threshold value T as an adjusted threshold value (S25). The processing in S25 is an example of determining a predetermined value based on a difference between a learning error when deep learning is executed by using a floating point number, and a learning error when deep learning is executed by using a fixed point number.

In this processing, since at the initial stage of the processing, the provisionally determined threshold value T is set as a value larger than assumed, the number of statistical information samples tends to be equal to or less than the threshold value, and a variable with a wide type of dynamic range is selected. As a result, the determination in S24 tends to be NO, and then, as the processing progresses, the determination in S24 becomes YES. It can be said that the processing in FIG. 37 is an example of a processing in a determination circuit that determines a predetermined value. It can be said that the host machine 3 executes the processing in FIG. 37, as an example of the determination circuit.

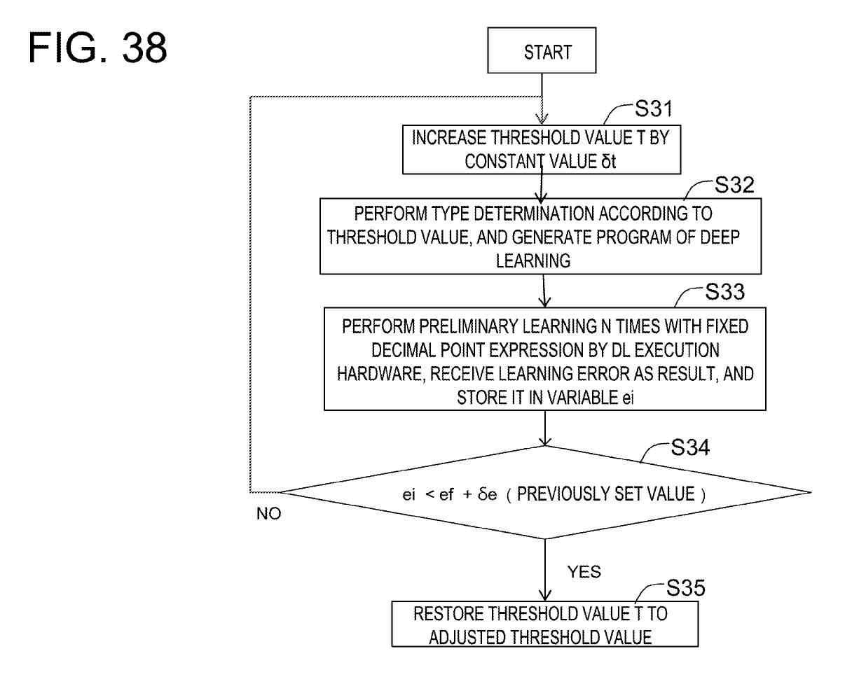

FIG. 38 exemplifies a second modification of the threshold value determination processing. In this processing, a provisionally determined threshold value T and a learning error ef in a case of learning by a floating decimal point expression are given as inputs. In this processing, the provisionally determined threshold value T is set as a value smaller than assumed. The variable type determination circuit 313 of the host machine 3 adds a constant value a to the threshold value T (S31). Then, the variable type determination circuit 313 of the host machine 3 performs type determination according to the threshold value, and generates a program of deep learning (S32). Thereafter, the host machine 3 executes preliminary learning N times in a fixed decimal point expression by using the DL execution processor 10A, receives a learning error as a result, and stores the learning error in a variable ei (S33). The processing in S33 is an example of executing deep learning a predetermined limited number of times.

Then, the host machine 3 determines whether the error of the variable ei is smaller than the sum (a determination value) of the error of the variable of and a previously set predetermined value be (S34). When it is determined that the error of the variable ei is equal to or more than the determination value, the host machine 3 returns the processing to S21, and executes an adjustment of increasing the threshold value. Meanwhile, when it is determined that the error of the variable ei is smaller than the determination value, the host machine 3 determines the threshold value T as an adjusted threshold value (S35). The processing in S35 is an example of determining a predetermined value based on a difference between a learning error when deep learning is executed by using a floating point number, and a learning error when deep learning is executed by using a fixed point number.

In this processing, since at the initial stage of the processing, the provisionally determined threshold value T is set as a value smaller than assumed, the number of statistical information samples tends to be larger than the threshold value, and a variable with a narrow type of dynamic range is selected. As a result, the determination in S34 tends to be NO, and then, as the processing progresses, the determination in S34 becomes YES. It can be said that the processing in FIG. 38 is an example of a processing in a determination circuit that determines a predetermined value. It can be said that the host machine 3 executes the processing in FIG. 38, as an example of the determination circuit.

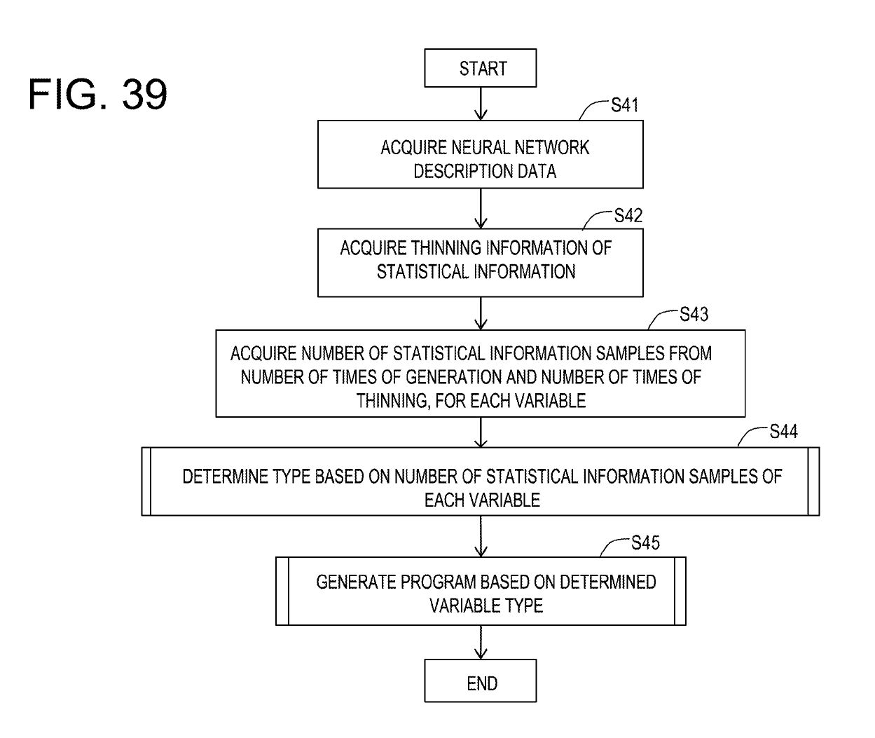

FIG. 39 exemplifies a program generation processing. In the processing, the host machine 3 acquires neural network description data of a program to be generated (S41). Then, the host machine 3 acquires the number of times of thinning of statistical information from the input (S42). Then, the host machine 3 acquires the number of statistical information samples from the number of times of generation and the number of times of thinning, for each variable (S43). Then, the variable type determination circuit 313 of the host machine 3 determines a type based on the number of statistical information samples of each variable (S44). Then, the program generation circuit 314 of the host machine 3 generates a program based on the determined variable type (S45).

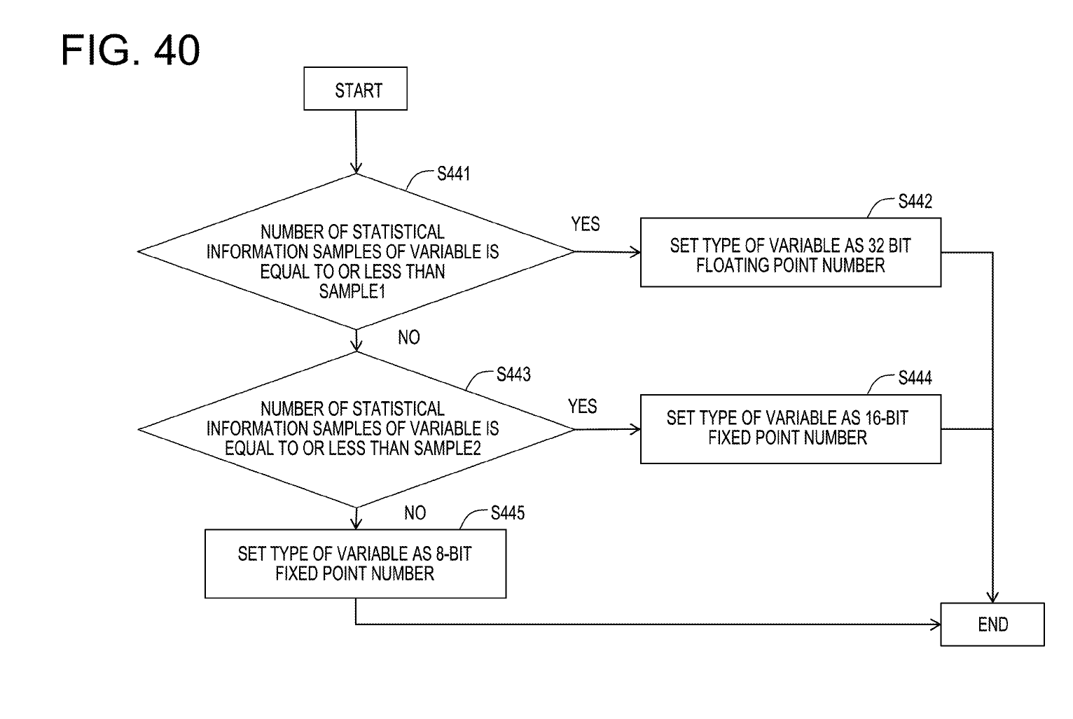

FIG. 40 exemplifies details of a processing (S44 in FIG. 39) of the variable type determination circuit 313. In this processing, the variable type determination circuit 313 determines whether the number of statistical information samples of a variable is equal to or less than a first predetermined value (sample1) (S441). When it is determined that the number of the statistical information samples of the variable is equal to or less than the first predetermined value (sample1), the variable type determination circuit 313 sets a type of the variable as a 32-bit floating point number (S442). When it is determined that the number of the statistical information samples of the variable is larger than the first predetermined value (sample1), the variable type determination circuit 313 determines whether the number of the statistical information samples of the variable is equal to or less than a second predetermined value (sample2>sample1) (S443). When it is determined that the number of the statistical information samples of the variable is equal to or less than the second predetermined value (sample2), the variable type determination circuit 313 sets a type of the variable as a 16-bit fixed point number (S444). When it is determined that the number of the statistical information samples of the variable is larger than the second predetermined value (sample2), the variable type determination circuit 313 sets a type of the variable as a 8-bit fixed point number (S445). It can be said that the processing in S442 is an example of setting a data type of a floating point number as target data when it is determined that the number of samples is smaller than a predetermined value. It can be said that the processing in S444 and S445 is an example of setting a data type of a fixed point number as target data when it is determined that the number of samples is larger than a predetermined value.

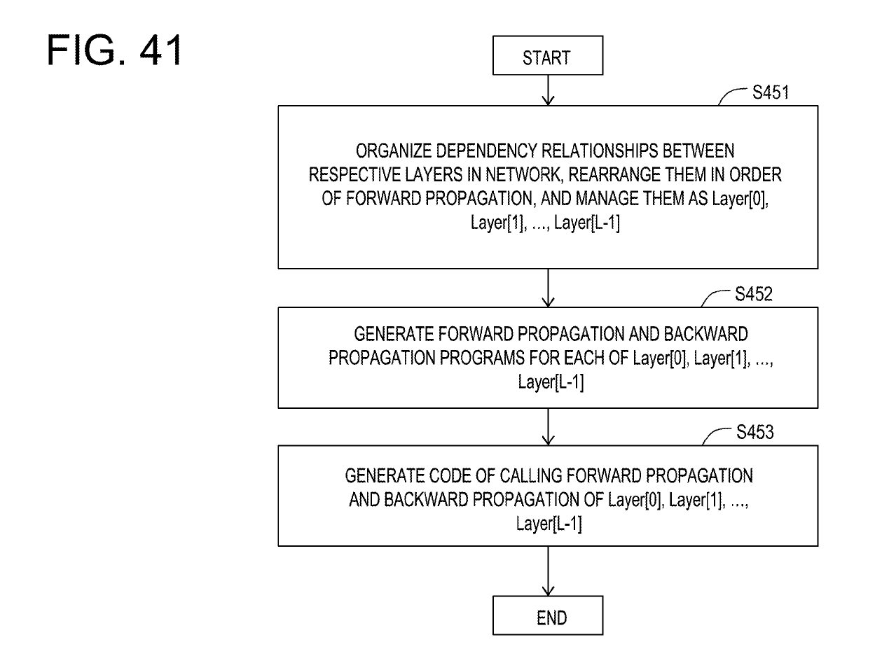

FIG. 41 exemplifies the processing of the program generation circuit 314. In this processing, the program generation circuit 314 organizes dependency relationships between respective layers in a neural network with a plurality of hierarchies. That is, the program generation circuit 314 rearranges the respective layers of the neural network in the order of forward propagation, and manages them as Layer[0], Layer[1], . . . , Layer[L−1] (S451). Then, the program generation circuit 314 generates forward propagation and backward propagation programs for each of Layer[0], Layer[1], . . . , Layer[L−1] (S452). The program generation circuit 314 generates a program by changing, for example, the number of inputs and the type of a variable in the template exemplified in FIG. 29. The program generation circuit 314 generates a code of calling a forward propagation and a backward propagation of Layer[0], Layer[1], . . . , Layer[L−1] (S453). Through the above described processing, a program that executes deep learning is generated.

<Execution of Generated Program>

The host machine 3 transmits the generated program to the DL execution processor 10A, so as to start execution of the program. The DL execution processor 10A executes a processing such as deep learning in the same procedure as that in the first embodiment, and returns a processing result to the host machine 3.

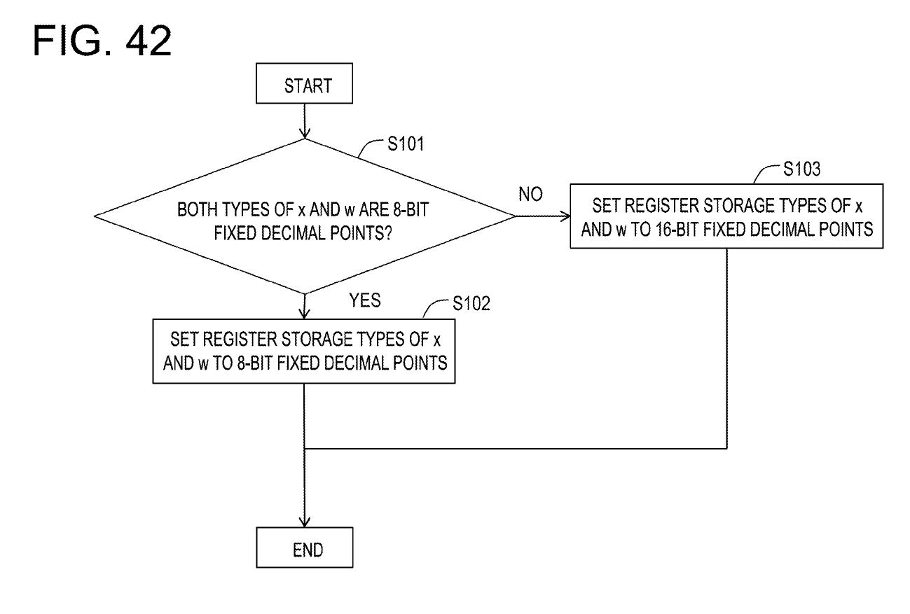

FIG. 42 is a view exemplifying a processing of setting a type conversion parameter according to a type, among processings executed by the DL execution processor 10A. The processing of setting the type conversion parameter according to a type is a processing of type matching of data to be operated when an operation is executed by the DL execution processor 10A. In the processing of setting the type conversion parameter according a type, the DL execution processor 10A basically executes type conversion in accordance with a variable with a large bit width. In an operation of a floating point number and a fixed point number, the DL execution processor 10A executes type conversion such that an operation is executed in accordance with the floating point number. Here, the type of an operation is one described for the DL execution processor 10A in FIG. 27 by (the type of a scalar operation) and (a vector operation (SIMD operation)).

Among them, FIG. 42 exemplifies a type conversion processing in the case where a multiplication, which is a part of a product-sum operation of a 16-bit fixed point number and a 8-bit fixed point number, is performed on variables (vectors) X and W. In this processing, it is assumed that the fixed point number that may be operated by the DL execution processor 10A is a 8-bit number or a 16-bit number. In this processing, the DL execution processor 10A determines whether both types of the variables X and W are 8-bit fixed point numbers (S101). When both types of the variables X and W are 8-bit fixed point numbers, the DL execution processor 10A sets register storage types of the variables X and W to 8-bit fixed point numbers (S102). Meanwhile, when both types of the variables X and W are not 8-bit fixed point numbers, the processor 10A sets register storage types of the variables X and W to 16-bit fixed point numbers (S103). Then, the DL execution processor 10A executes an operation on the variables after the type conversion.

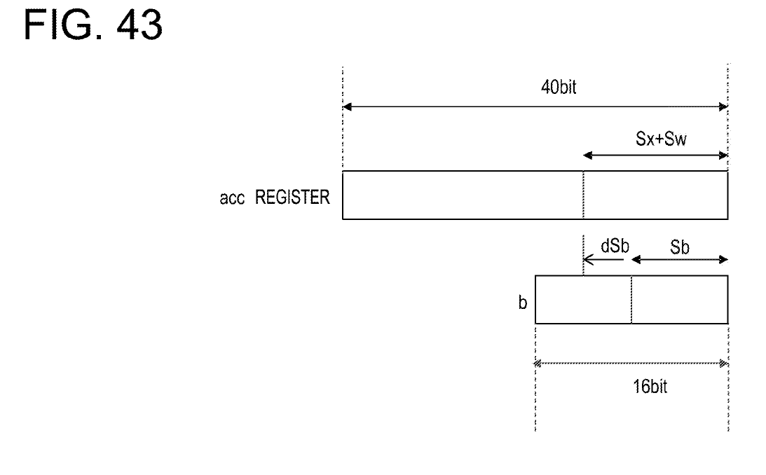

FIG. 43 is a view exemplifying setting of a shift width. Here, it is assumed that an operation is, for example, X*W+b (as the inner product of a vector X and a vector W, and the addition of a bias b) and the operation result is integrated to an accumulator register acc. It is assumed that scale factors of respective elements of the vector X and the vector W, that is, shift amounts of decimal point positions, are Sx and Sw, respectively. Then, a scale factor of the accumulator register Acc is the result of multiplication of respective elements of the vector X and the vector W, and thus is Sx+Sw. Therefore, assuming that a scale factor of the bias b is Sb, the DL execution processor 10A needs to perform shifting to the left by AWb=Sx+Sw−Sb.

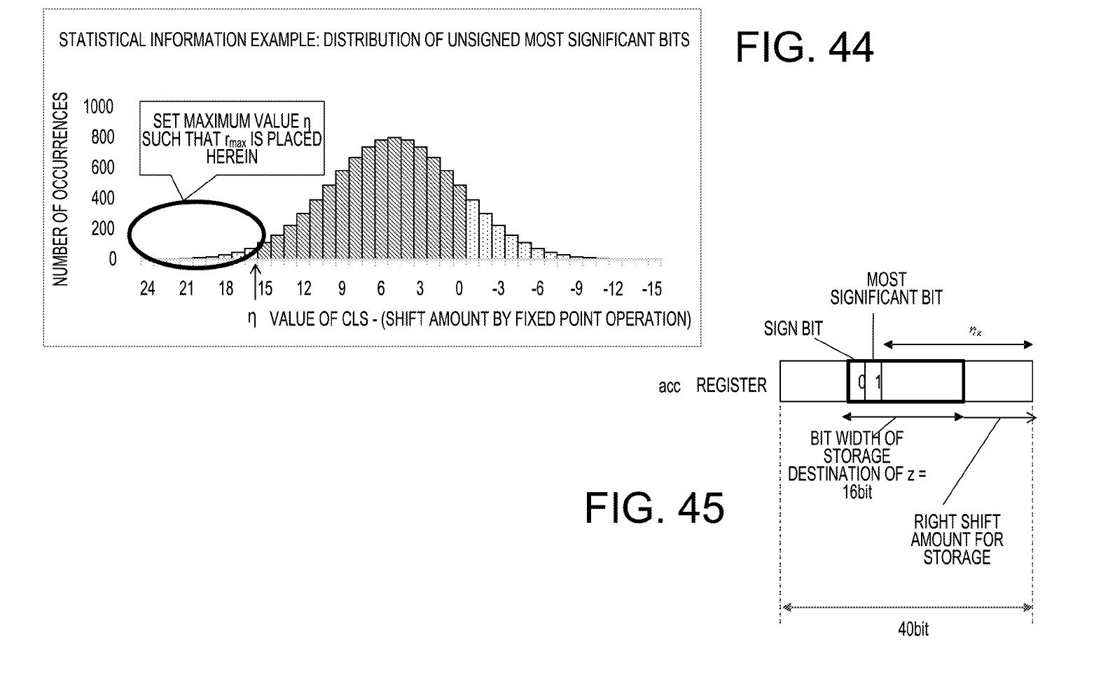

FIG. 44 is a view exemplifying a processing of setting a rate of overflow from the distribution of positions of most significant bit at which value is not the same to the sign bit, and determining the most significant bit position η (eta). In FIG. 44, in the loop of a program obtained by the same configuration as that in the first embodiment, a digit position at the point where the rate of overflow becomes rₘₐₓ in the distribution of the positions of most significant bit at which value is not the same to the sign bit is set to η.

FIG. 45 is a view exemplifying a method of determining scale factors to be used in a mini batch subsequent to the operation result Z by the operation Z=X*W+b. The DL execution processor 10A considers bits 0 to η (the digit position determined in FIG. 44) as an effective bit width in the subsequent mini batch. The right shift amount ΔSz when the operation result Z by the operation Z=X*W+b is stored in a register may be obtained by ΔSz=η+2−β. Here, β is a bit width of a register as a storage destination, and has, for example, 16 bits or 8 bits. Therefore, a scale factor of a variable Z in the operation result storage destination to be used in the subsequent mini batch may be obtained by Sz=Sx+Sw−ΔSz. The DL execution processor 10A may set a decimal position of each fixed point number by using the scale factor determined in this manner, and execute each operation of the subsequent mini batch.

For example, since an input X of each layer in deep learning is the same as an output Z of a preceding layer (a lower-order layer in a forward direction propagation), the DL execution processor 10A may use the scale factor of the output Z of the preceding layer, as it is. The DL execution processor 10A may update the scale factors of the weighting factor W and the bias b at the time of backward direction propagation.

### Effect of Second Embodiment

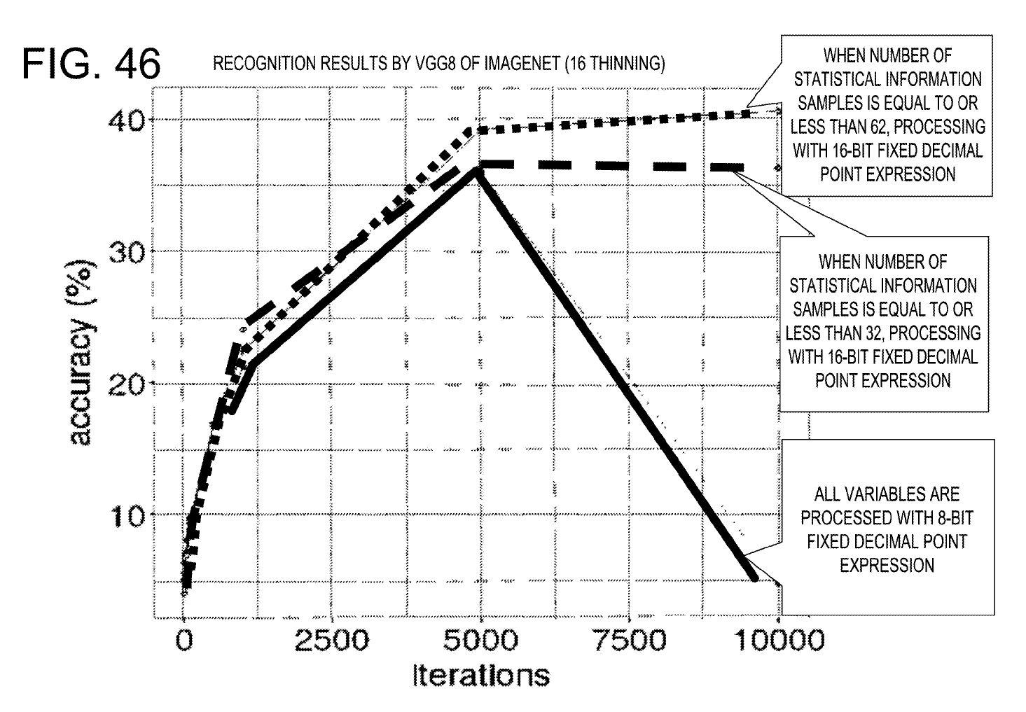

FIG. 46 exemplifies recognition results by an eight-hierarchy network VGG8 of image database ImageNet on the Internet. In this example, statistical information is thinned to 1/16. As in the drawing, recognition accuracy is improved when most variables are processed with a 8-bit fixed point number expression, and some variables (e.g., in one mini batch, equal to or less than 62 (the number of samples), or equal to or less than 32 (the number of samples)) are processed with an extended bit width such as a 16-bit fixed point number. The same also applies to a case where some variables are processed with a floating point number expression. Therefore, according to the procedure and the information processing method in the second embodiment, the host machine 3 may perform an operation including a learning processing in a neural network etc., with a small bit width by using a fixed point number, in which a circuit scale is suppressed like in the DL execution processor 10A, thereby improving the recognition accuracy.

The host machine 3 determines a threshold value T by the result obtained when learning is executed N times as the number of times of learning smaller than the number of times of actual learning, and determines whether the number of statistical information samples is sufficient based on the corresponding threshold value T, so as to select a type of a variable. Thus, the host machine 3 may reflect the learning result, and determine the threshold value as to whether the number of the statistical information samples is sufficient.

Since the host machine 3 determines a threshold value based on an error of learning executed by the DL execution processor 10A, it is possible to determine a type of a variable to be used for learning by a threshold value suitable for actual learning. When determining the type, the host machine 3 causes the DL execution processor 10A to perform learning N times that is smaller than the number of times of normal learning, and thus the threshold value may be determined in a short time with a low load.

The host machine 3 compares a learning error ef when learning is performed using a floating point number, to a learning error ei when learning is performed using a fixed point number. Then, a processing is repeated until the learning error ei sufficiently approaches the learning error ef to determine a threshold value. Therefore, even when the fixed point number is used, the threshold value T may be set such that the learning error ei in the fixed point number approaches the learning error of in the floating point number.

The host machine 3 in the second embodiment acquires neural network description data to calculate the number of statistical information samples. Thus, it is possible to acquire the number of samples with a high accuracy, and to determine a type of a variable. After determining the type of the variable, the host machine 3 in the second embodiment changes the type of the variable by using a template to generate a program. Thus, it is possible to simply generate the program.

<Modification>

In the second embodiment as described above, in an information system including the host machine 3 and the DL execution hardware 1A, the host machine 3 generates a learning program. However, the host machine 3 and the DL execution hardware 1A may be an integrated computer. That is, the processor 10 described in the first embodiment or the DL execution processor 10A of FIG. 27 may generate a learning program and execute the generated learning program. When the DL execution processor 10A in FIG. 27 generates a learning program and executes the generated learning program, it can be said that the DL execution processor 10A as an example of an arithmetic processing circuit executes a processing as a generation circuit that generates a program with the same processor. In FIG. 23, the host machine 3 and the DL execution hardware 1A may be accommodated in a single housing, or may be accommodated in different housings.

<Computer-Readable Recording Medium>

A program causing a computer, other machines, or a device (hereinafter, a computer or the like) to implement any one among the above described functions may be recorded in a recording medium readable by the computer or the like Then, by causing the computer or the like to read and execute the program in the recording medium, the corresponding function may be provided.

Here, the recording medium readable by the computer or the like refers to a recording medium that accumulates information such as data or programs by an electrical, magnetic, optical, mechanical, or chemical action, and then is readable from the computer or the like. Among such recording media, as one removable from the computer or the like, for example, there are a flexible disk, a magneto-optical disk, a CD-ROM, a CD-R/W, a DVD, a Blu-ray disk, a DAT, a 8 mm tape, and a memory card such as a flash memory As a recording medium fixed to the computer or the like, there are, for example, a hard disk and a read-only memory (ROM). A solid state drive (SSD) may be used as not only a recording medium removable from the computer or the like, but also a recording medium fixed to the computer or the like.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. An information processing apparatus comprising:
a memory; and
a processor coupled to the memory and configured to:
acquire statistical information including a distribution of operation result values from the memory,
when it is determined that a number of acquired statistical information samples is larger than a predetermined value, generate a program by setting a data type for which a ratio of a maximum value to a minimum value of values that can be expressed is smaller among data types usable for target data in an operation as the target data, and
when it is determined that the number of acquired statistical information samples is smaller than the predetermined value, generate the program by setting the data type for which the ratio of the maximum value to the minimum value of values that can be expressed is larger among data types usable for target data in the operation as the target data.

2. The information processing apparatus according to claim 1, wherein the processor is configured to:
execute at least one of a fixed point number operation and a floating point number operation,
set a data type of a fixed point number as the target data when it is determined that the number of samples is larger than the predetermined value, and
set the data type of a floating point number as the target data when it is determined that the number of samples is smaller than the predetermined value.

3. The information processing apparatus according to claim 1,
wherein the program is a program for executing a process by a neural network with a plurality of hierarchies.

4. The information processing apparatus according to claim 3, wherein the processor is configured to:
acquire the number of times of operation in each layer of the neural network from definition information defining the neural network, and
acquire the number of the statistical information samples based on the number of times of operation in each layer of the neural network and a ratio of acquisition of the statistical information with respect to the number of times of operation in the arithmetic processing.

5. The information processing apparatus according to claim 1,
wherein the processor is configured to determine the predetermined value based on an operation in the arithmetic processing.

6. The information processing apparatus according to claim 4,
wherein the processor is configured to determine the predetermined value based on a difference between a learning error when deep learning is executed using a floating point number and a learning error when the deep learning is executed using a fixed point number.

7. The information processing apparatus according to claim 5,
wherein the processor is configured to acquire the difference by the deep learning performed a predetermined limited number of times.

8. An information processing method executed by a processor included in an information processing apparatus, the method comprising:
acquiring statistical information including a distribution of operation result values from the memory;
when it is determined that a number of acquired statistical information samples is larger than a predetermined value, generating a program by setting a data type for which a ratio of a maximum value to a minimum value of values that can be expressed is smaller among data types usable for target data in an operation as the target data; and
when it is determined that the number of acquired statistical information samples is smaller than the predetermined value, generating the program by setting the data type for which the ratio of the maximum value to the minimum value of values that can be expressed is larger among data types usable for target data in the operation as the target data.

9. The information processing method according to claim 8, further comprising:
executing at least one of a fixed point number operation and a floating point number operation,
setting a data type of a fixed point number as the target data when it is determined that the number of samples is larger than the predetermined value, and
setting the data type of a floating point number as the target data when it is determined that the number of samples is smaller than the predetermined value.

10. The information processing method according to claim 8,
wherein the program is a program for executing a process by a neural network with a plurality of hierarchies.

11. The information processing method according to claim 8, further comprising:
acquiring a number of times of operation in each layer of the neural network from definition information defining the neural network, and
acquiring the number of the statistical information samples based on the number of times of operation in each layer of the neural network and a ratio of acquisition of the statistical information with respect to the number of times of operation in the arithmetic processing.

12. The information processing method according to claim 8, further comprising:
determining the predetermined value based on an operation in the arithmetic processing.

13. The information processing method according to claim 8, further comprising:
determining the predetermined value based on a difference between a learning error when deep learning is executed using a floating point number and a learning error when the deep learning is executed using a fixed point number.

14. The information processing method according to claim 13, wherein the difference is acquired by performing a predetermined number of the deep learning.

15. A non-transitory computer-readable recording medium storing a program that causes a processor included in an information processing apparatus to execute a process, the process comprising:
acquiring, by the processor, statistical information including a distribution of operation result values from the memory;
when it is determined that a number of acquired statistical information samples is larger than a predetermined value, generating a program by setting a data type for which a ratio of a maximum value to a minimum value of values that can be expressed is smaller among data types usable for target data in an operation as the target data; and
when it is determined that the number of acquired statistical information samples is smaller than the predetermined value, generating the program by setting the data type for which the ratio of the maximum value to the minimum value of values that can be expressed is larger among data types usable for target data in the operation as the target data.
